(19) United States
(12) Patent Application Publication
(10) Pub. No.: US 2026/0086784 A1
(43) Pub. Date: Mar. 26, 2026

(54) INFORMATION PROCESSING DEVICE, INFORMATION PROCESSING METHOD, AND INFORMATION PROCESSING PROGRAM

(71) Applicant: SolvifAI Co., Ltd., Tokyo (JP)

(72) Inventors: Masayoshi Yuasa, Tokyo (JP); Ryodai Someya, Tokyo (JP)

(73) Assignee: SolvifAI Co., Ltd., Tokyo (JP)

(21) Appl. No.: 19/409,118

(22) Filed: Dec. 4, 2025

Related U.S. Application Data
(63) Continuation of application No. PCT/JP2025/017602, filed on May 14, 2025.

(30) Foreign Application Priority Data
May 16, 2024 (JP) 2024-079817

(51) Int. Cl. G06F 8/35; G06F 16/3329

(52) U.S. Cl. CPC G06F 8/35; G06F 16/3329

(57) ABSTRACT

An information processing device includes a past deliverable acquisition unit configured to acquire past deliverables created in a past in a waterfall system development including a plurality of development steps; a past deliverable analyzer configured to analyze a format of the past deliverables; an input screen provider configured to provide an input screen for entering input items needed for creating a new deliverable; a prompt generator configured to generate a prompt for automatically generating a new deliverable based on the format of the past deliverables and the input items entered on the input screen; a prompt provider configured to provide the prompt to a large language model; a new deliverable acquisition unit configured to acquire, from the large language model, the new deliverable generated in response to the prompt; and a new deliverable provider configured to provide the new deliverable acquired by the new deliverable acquisition unit.

### CROSS-REFERENCE TO RELATED APPLICATIONS

This application is a continuation application of International Application No. PCT/JP2025/017602, filed May 14, 2025, which claims priority to Japanese Patent Application No. 2024-079817, filed May 16, 2024, each of which is incorporated herein by reference in its entirety.

### TECHNICAL FIELD

This disclosure relates to an information processing device, information processing method, and information processing program.

### BACKGROUND

Information technology (IT)-based project management tools have been used to manage projects such as system development in recent years. In project management tools, technologies for automatically generating deliverables to be created in a project are known. For example, Japanese Unexamined Patent Application Publication No. 2022-079589 discloses a technique in which, on the basis of a project specified by an operator, records linked to a project number included in a specified record of project data are acquired from purchase slip data, expense slip data, and work report data; a rate linked to a client included in the specified record is acquired from a client rate master; a selling unit price and selling amount for purchases and a selling amount for labor cost are computed on the basis of the acquired records and the rate; and project detail data (PJ detail data) are created on the basis of the acquired records and the computed amounts.

However, in waterfall system development involving multiple development steps, the deliverables created in each development step are interrelated. Accordingly, when new deliverables are created, the consistency with deliverables created in the past needs to be checked, and thus the work to check the consistency may cost man-hours to create the deliverables.

In addition, when descriptions are modified in the creation of the deliverables, the descriptions of each of the deliverables involved in the waterfall system development need to be modified, and thus the modification work may cost man-hours to create the deliverables.

It could therefore be helpful to provide an information processing device, an information processing method, and an information processing program that are capable of reducing the man-hours needed to create deliverables.

### SUMMARY

Disclosed herein is:

An information processing device includes: a past deliverable acquisition unit configured to acquire past deliverables created in a past in a waterfall system development including a plurality of development steps; a past deliverable analyzer configured to analyze a format of the past deliverables acquired by the past deliverable acquisition unit; an input screen provider configured to provide an input screen for entering input items needed for creating a new deliverable; a prompt generator configured to generate a prompt for automatically generating a new deliverable on the basis of the format of the past deliverables analyzed by the past deliverable analyzer and the input items entered on the input screen provided by the input screen provider; a prompt provider configured to provide the prompt generated by the prompt generator to a large language model; a new deliverable acquisition unit configured to acquire, from the large language model, the new deliverable generated in response to the prompt provided by the prompt provider; and a new deliverable provider configured to provide the new deliverable acquired by the new deliverable acquisition unit.

In some embodiments, past deliverables created in the past in a waterfall type system development involving multiple development steps are acquired; the format of the acquired past deliverables is analyzed; an input screen for entering input items needed for creating a new deliverable is provided; a prompt for automatically generating a new deliverable on the basis of the format of the analyzed past deliverables and the input items entered on the input screen is generated; the generated prompt is provided to the large language model; the new deliverable generated in response to the provided prompt from the large language model is acquired; and the acquired new deliverable is provided, thereby reducing the man-hours needed to create the deliverables.

### BRIEF DESCRIPTION OF THE DRAWINGS

FIG. 1 shows a diagram illustrating an example of an overview of an information processing device according to an embodiment.

FIG. 2 shows a diagram illustrating an example of the positioning of steps (processes) and the connections between the deliverables in each step (process) according to the embodiment.

FIG. 3 shows a diagram illustrating an example of a configuration of the information processing device according to the embodiment.

FIG. 4 shows a diagram illustrating a first example of an input screen for automatic generation and updating of deliverables provided by the information processing device according to the embodiment.

FIG. 5 shows a diagram illustrating a second example of an input screen for automatic generation and updating of deliverables provided by the information processing device according to the embodiment.

FIG. 6 shows a diagram illustrating a third example of an input screen for automatic generation and updating of deliverables provided by the information processing device according to the embodiment.

FIG. 7 shows a diagram illustrating a fourth example of an input screen for automatic generation and updating of deliverables provided by the information processing device according to the embodiment.

FIG. 8 shows a diagram illustrating a fifth example of an input screen for automatic generation and updating of deliverables provided by the information processing device according to the embodiment.

FIG. 9 shows a diagram illustrating a sixth example of an input screen for automatic generation and updating of deliverables provided by the information processing device according to the embodiment.

FIG. 10 shows a diagram illustrating a seventh example of an input screen for automatic generation and updating of deliverables provided by the information processing device according to the embodiment.

FIG. 11 shows a diagram illustrating an eighth example of an input screen for automatic generation and updating of deliverables provided by the information processing device according to the embodiment.

FIG. 12 shows a block diagram illustrating an example of a hardware configuration of the information processing device according to the embodiment.

FIG. 13 shows a diagram illustrating an example of a management screen for centralized management of deliverables provided by the information processing device according to the embodiment to a user terminal.

FIGS. 14A through 14C each show a diagram illustrating a case where the information processing device according to the embodiment creates a programming code as a deliverable.

FIG. 15 shows a flowchart illustrating a first example of operations of the information processing device according to the embodiment.

FIG. 16 shows a flowchart illustrating a second example of operations of the information processing device according to the embodiment.

FIG. 17 shows a flowchart illustrating a third example of operations of the information processing device according to the embodiment.

FIG. 18 shows a flowchart illustrating a fourth example of operations of the information processing device according to the embodiment.

FIG. 19 shows a diagram illustrating a ninth example of an input screen for automatic generation and updating of deliverables provided by an information processing device according to a second embodiment.

FIG. 20 shows a diagram illustrating a tenth example of an input screen for automatic generation and updating of deliverables provided by the information processing device according to the second embodiment.

FIG. 21 shows a diagram illustrating an eleventh example of an input screen for automatic generation and updating of deliverables provided by the information processing device according to the second embodiment.

FIGS. 22A through 22D each show a diagram illustrating a twelfth example of an input screen for automatic generation and updating of deliverables provided by the information processing device according to the second embodiment.

FIGS. 23A through 23D each shows a diagram illustrating a thirteenth example of an input screen for automatic generation and updating of deliverables provided by the information processing device according to the second embodiment.

FIG. 24 shows a diagram illustrating a fourteenth example of an input screen for automatic generation and updating of deliverables provided by the information processing device according to the second embodiment.

FIGS. 25A through 25D each show a diagram illustrating a fifteenth example of an input screen for automatic generation and updating of deliverables provided by the information processing device according to the second embodiment.

FIGS. 26A through 26C each shows a diagram illustrating a sixteenth example of an input screen for automatic generation and updating of deliverables provided by the information processing device according to the second embodiment.

FIGS. 27A through 27C each show a diagram illustrating a seventeenth example of an input screen for automatic generation and updating of deliverables provided by the information processing device according to the second embodiment.

FIGS. 28A through 28D each show a diagram illustrating an eighteenth example of an input screen for automatic generation and updating of deliverables provided by the information processing device according to the second embodiment.

FIGS. 29A through 29C each show a diagram illustrating a nineteenth example of an input screen for automatic generation and updating of deliverables provided by the information processing device according to the second embodiment.

FIGS. 30A and 30B each show a diagram illustrating a twentieth example of an input screen for automatic generation and updating of deliverables provided by the information processing device according to the second embodiment.

FIGS. 31A and 31B each show a diagram illustrating a twenty-first example of an input screen for automatic generation and updating of deliverables provided by the information processing device according to the second embodiment.

FIG. 32 shows a diagram illustrating a twenty-second example of an input screen for automatic generation and updating of deliverables provided by the information processing device according to the second embodiment.

### DETAILED DESCRIPTION

Our information processing device, information processing method, and information processing program according to a representative example will be described with reference to the drawings. The contents contained in multiple figures may be omitted to avoid redundant descriptions.

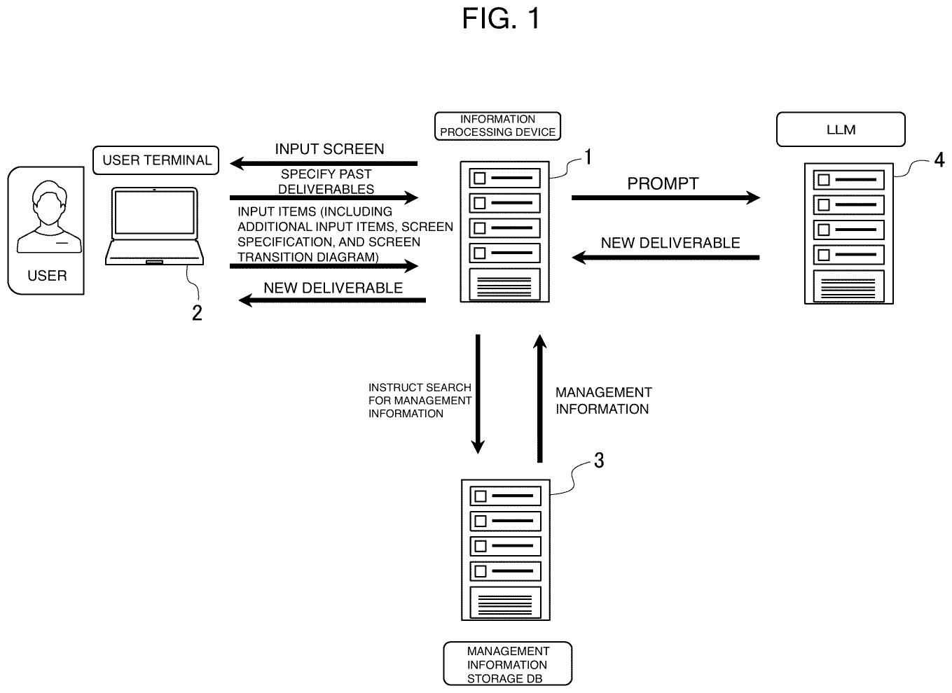

First, with reference to FIG. 1, an overview of an information processing device will be described. FIG. 1 shows a diagram illustrating an example of an overview of an information processing device according to an embodiment.

In FIG. 1, the information processing device 1 corresponds to a device that provides a user (hereinafter, referred to as a “user”) that creates deliverables for waterfall system development with newly generated deliverables. The system development according to this embodiment refers to development of systems using technologies related to IT or digital trans(X)formation (DX) (hereinafter, “IT or DX” may be referred to as “IT/DX”). The DX is directed to, for example, the digitization of information or the transformation of management using digitized information. The waterfall system development corresponds to a development method in which development is carried out sequentially from upstream phases to downstream phases of development steps, and specifically, a development in the downstream phases is performed on the basis of the development results obtained in the development steps upstream from a current step (step under focus), with the premise that no return from downstream to upstream is made during the process. The waterfall system development is suitable for system development in which modifications in the development results in the upstream development steps are less likely to occur than in the current step.

The deliverables may include not only materials (independent of file format or format style) but also programming code, source code, test scenarios, and test results generated by coding as well as materials that summarize these. Further, the deliverables may include objects and information, for example, that result from the course of or as a result of actions taken with goals and objectives.

In this embodiment, past deliverables correspond to deliverables that were created in the past. Also, new deliverables correspond to newly created (generated) deliverables. The past deliverables may include deliverables of the same type as the deliverables newly created in the same development step as that of the new deliverables, and deliverables created in the past in the development steps upstream from the current step (the step under focus) of the new deliverables. If the past deliverables are the same type of deliverables as the new deliverables, the past deliverables are used as samples for creating the new deliverables. In contrast, if the past deliverables correspond to deliverables that were created in the past in the development steps upstream from the current step of the new deliverables, then the new deliverables correspond to interrelated deliverables that are created in the development step downstream from that of the past deliverables. In the waterfall system development, new deliverables for development in the downstream phases are created on the basis of the past deliverables created in the past in the development step upstream from the current step. The created new deliverables are treated as past deliverables in further downstream development steps, and new deliverables are further generated.

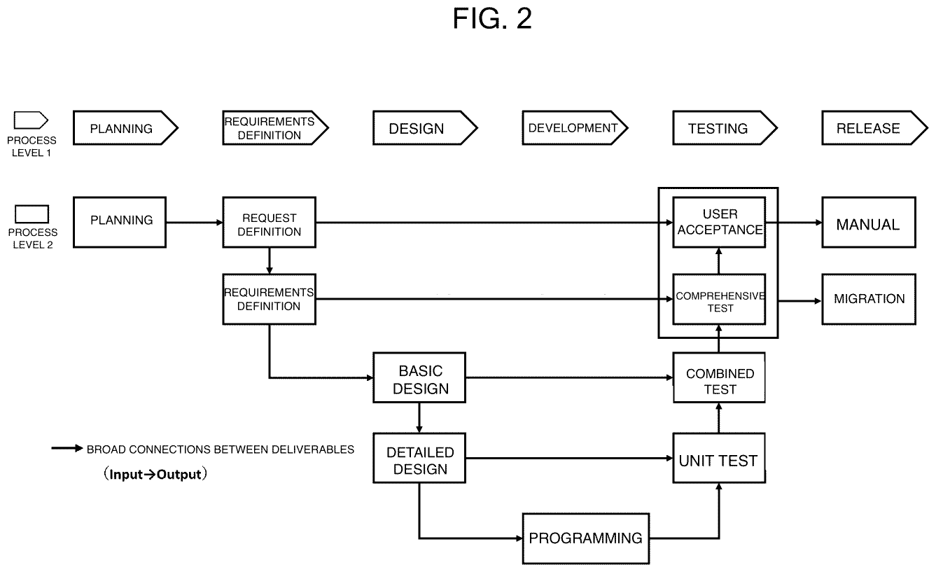

With reference now to FIG. 2, examples of deliverables created in the development steps (processes) of the waterfall system development will be illustrated. FIG. 2 illustrates an example of the positioning of the steps (processes) and the connections between the deliverables in each step (process). Each deliverable is created on the basis of the past deliverables created in the development steps upstream from the current step. In the following description, a case in which the development steps (processes) are performed in the order of planning, requirements definition, design, development, testing, and release will be illustrated. However, this embodiment is not limited to the development steps (processes) above. For example, it may include other development steps (processes), or it may omit some development steps (processes).

### Process Level 1: Planning Process

### Process Level 2: Planning

Mid-Term Business Plan (e.g., Digital Strategy Document): describes mid-term business goals of an organization and plans for using digital technology to support the goals. The mid-term business plan may include streamlining operations through digitization, developing a new customer base, or strategies to promote innovation.

Project Plan: comprehensively describes objectives, scope, schedule, release date, budget, or risk management plan of a project. The project plan provides basic guidelines for project management and execution.

### Process Level 1: Requirements Definition Process

### Process Level 2: Requirements Definition

List of Issues/Proposed Solutions: where issues related to the project or business improvement are listed and specific solutions for respective issues are proposed. Prioritization of issues or impact, for example, may be noted.

Problem Cause Analysis Diagram: corresponds to a diagram that systematically analyzes and visually displays the causes of a problem when it occurs. In the problem cause analysis, a fishbone diagram (cause and effect diagram) or 5Whys analysis, for example, is used.

List of Requirements: where business needs or requirements are listed for the project or system. The details of the requirements, related work, importance, or priority of the requirements, for example, are described.

Requirements Structure Diagram: shows a diagram illustrating the relationship and structure between the requirements. It is used to visually represent the dependency or hierarchical structure of the requirements and to efficiently manage overall requirements.

### Process Level 2: Requirements Definition

List of Tasks to be Systematized (Requirements Organization Table): lists the tasks to be systematized and describes the basic functional or non-functional requirements, evaluation, priority, or reasons for evaluation for each business requirement or demand.

Requirements Definition Document: describes in detail the specific requirements for the system or project. It covers functional, non-functional, or user requirements, for example, and serves as the basis for subsequent design or development steps. Timelines or estimated costs, for example, may be described.

### Process Level 1: Design Process

### Process Level 2: Basic Design

UI Design Document: describes an overview of the user interface, screen transition diagrams, or wireframes, for example.

System Architecture Design Document: defines the overall system structure or major components and their relationships.

Data Model Design Document: describes the database schema, entity relationship (ER) diagram, or data dictionary, for example.

Security Design Document: describes in detail the design or countermeasures and policies to meet security requirements.

Basic Design Document: describes the outline of the system, main functions and data structures, or interface definitions, for example.

### Process Level 2: Detailed Design

Screen Specification: defines detailed layout, operation method, or processing logic for each of the screens.

Application Programming Interface (API) Design Document: describes the specification of the API used in the interface with external systems or other modules.

Detailed Database Design Document: describes the specific database designs such as table definitions, index designs, or relational integrity constraints.

Detailed Design Document: describes detailed process flow, algorithm, data structure, or interface design for each of the functions.

### Process Level 1: Development Process

### Process Level 2: Programming

Source Code: corresponds to text in a programming language that specifically specifies the operation of the software. Specific code is written to implement the functionality of the system.

### Process Level 1: Testing Process

### Process Level 2: Unit Test

Unit Test Plan: describes the test objectives, environment, schedule, responsible person, test procedures for each function, input data, and expected results.

Unit Test Report: describes summary of test results, problems, suggestions for improvement, list of bugs found and their status and priority.

### Process Level 2: Combined Test

Combined Test Design Document: describes the test objectives, environment, schedule, responsible person, test procedures for the interfaces between modules and the combined unit, input data, and expected results.

Combined Test Report: describes summary of test results, problems, suggestions for improvement, list of bugs found and their status, and priority.

### Process Level 2: Comprehensive Test

Comprehensive Test Design Document: describes the test objectives, environment, schedule, responsible person, test procedures covering the entire system functionality, input data, and expected results.

Comprehensive Test Report: describes summary of test results, problems, suggestions for improvement, list of bugs found and their status, and priority.

### Process Level 2: User Acceptance Test

Acceptance Test Plan: describes test objectives, environment, schedule, responsible person, test procedures on the basis of scenarios used by actual users, input data, and expected results.

Acceptance Test Report: describes summary of test results, problems, suggestions for improvement, list of bugs found and their status, and priority.

### Process Level 1: Release Process

### Process Level 2: Manual Creation

User Manual: describes user documentation including system usage, troubleshooting, and FAQs.

Operation Manual: describes system operation methods, maintenance plans, and emergency response procedures.

### Process Level 2: Migration

Migration Plan: describes migration procedures to production environment, schedule, risk management, and backup plan.

Migration Test Report: records the results of testing in the production environment, problems, and final approval.

Project Completion Report: describes summary of the project results, degree of accomplishment, outstanding issues, and suggestions for the future.

The deliverables described above illustrate some of the deliverables created in the waterfall system development, and dozens of different deliverables may be created in actual system development. Since deliverables are created on the basis of the deliverables created in the upstream development steps, in the waterfall system development, if the deliverables in the downstream development steps are modified, reconsideration (rework) in the upstream development process may occur, and the effects of the modifications in the deliverables on the contents of other deliverables need to be checked.

Next, the manner in which deliverables created in downstream development steps (phases) on the basis of the business requirements obtained in upstream development steps (phases) transition, as the development steps (phases) proceed in the order of planning, requirements definition, design, development, testing, and release, will be described by using a specific project as an example. It is assumed that the specific project will proceed under the following assumptions. The business requirements refer to the contents and conditions of the business to be systematized.

### Assumption

A person working in the information systems department of a manufacturing company was assigned as a project manager (PM) for a project to introduce a new supply chain management system that the company was considering implementing. During the upstream process (requirements definition phase) of this project, the following were confirmed as the contents (business requirements) that were stated by the person in charge of the business during interviews with the business department. He said “The current system does not allow us to check the progress of the production line in real time. This often causes delays in the preparation of the next process. If whether a particular portion is the bottleneck or whether other problems are occurring can be grasped in real time, they can be quickly addressed.” In what way the contents of this hearing (business requirements) are developed into what deliverables in the subsequent process will be described below along the development steps (process).

### Process Level 1: Requirements Definition Process

### Process Level 2: Requirements Definition

On the basis of direct feedback (business requirements) from the manufacturing department, the need to check the progress of the production line in real time is documented.

### Typical Deliverables: Requirements Definition Document

### Process Level 2: Requirements Definition

The business requirement of “allowing the progress of the production line to be checked in real time” is converted into a specific system requirement, and the functions that the system needs to fulfill are documented. The system requirements assumed for the business requirements above are as follows.

### 1. Real-Time Progress Display of Production Line

The progress at each step of the production line is displayed in real time.

### 2. Bottleneck Detection Function

The bottlenecks that occur during the production process are automatically detected and notified.

3. Quick problem addressing support

A response guide is provided on the system when a problem occurs to assist in prompt problem resolution.

### Typical Deliverables: Requirements Definition Document

### Process Level 1: Design Process

### Process Level 2: Basic Design

On the basis of the above requirements, the overall system structure, data models, and interfaces with external systems, for example, are defined. General methods of what way the requirements are met are also determined.

### Typical Deliverables: Basic Design Documents

### Process Level 2: Detailed Design

On the basis of the determined contents in the basic design, a specific program structure, database schema, and detailed communication methods with external systems are designed.

### Typical Deliverables: Detailed Design Documents

### Process Level 1: Development Process

### Process Level 2: Programming

On the basis of the detailed design, program of the system is created. At this stage, the code is written and the actual system is built.

### Typical Deliverables: Source Code, and Development Document

### Process Level 2: Unit and Combined Testing

The developed functions are tested for correct operation on a stand-alone basis, followed by combined tests between related functions. This ensures that the individual components correctly cooperate.

### Typical Deliverables: Test Specifications, and Test Reports

### Process Level 2: Comprehensive and Acceptance Test (UAT)

Testing to ensure that the entire system meets requirements and functions properly in the environment of the end-users. Acceptance test by the end-users is also included. In addition, the following are examples of comprehensive/acceptance test (UAT) items for each system requirement organized in the requirements definition phase.

### 1. Real-Time Progress Display of Production Line

Whether the progress of the production line is accurately displayed in real time is checked.

Whether the progress status of each process (completed, in progress, or pending, for example) is accurately reflected is checked.

Whether the system display is updated without delay is checked.

Whether multiple production lines can be monitored simultaneously is checked.

### 2. Bottleneck Detection Function

Whether immediate notification is performed when bottlenecks occur is checked.

Whether the locations of the bottlenecks can be accurately specified (in which process they occur) is checked.

Whether detailed information on the occurred bottlenecks (cause, and scope of impact, for example) is provided is checked.

Whether the system returns to a normal state after the bottlenecks are resolved is checked.

### 3. Quick Problem Response Support

Whether the system automatically provides a specific response guide when a problem occurs is checked.

Whether the response guide is specific enough to help solve the actual problem is checked.

Whether the problem is resolved quickly as a result of implementing the solutions provided by the system is checked.

Whether the end-users can easily access and understand the problem resolution guide is checked.

### Typical Deliverables: UAT Test Plan, and UAT Test Report

### Process Level 1: Release Process

### Process Level 2: Introduction

The system is deployed (developed, arranged) to the actual operational environment, and needed data migration and user training are implemented.

### Typical Deliverables: Deployment Plan, and Training Materials

### Process Level 2: Operation and Maintenance

Once the system is up and running, problems are corrected as they arise and the system continues to be updated and improved as needed.

### Typical Deliverables: Operation Manuals, Maintenance Logs, and Improvement Proposal Documents

As shown in FIG. 1, the information processing device 1 is connected to a user terminal 2, management information storage DB3, and a large language model (LLM) 4 in a communicational manner. The user terminal 2 corresponds to a terminal used by a user.

The information processing device 1 provides an input screen to the user terminal 2. The input screen corresponds to a screen for allowing the user to enter needed information to create a new deliverable, and is displayed on the user terminal 2. The input screen may include an input unit for specifying past deliverables created in the past in the waterfall system development. The input screen may include an input unit for entering additional input items, screen specifications, or screen transition diagrams, for example.

The information processing device 1 acquires the designations of past deliverables entered on the input screen. The designations of the past deliverables may be performed, for example, by specifying the path to the destination where the files of the past deliverables are stored, by specifying the file names, or by transmitting the files themselves.

The information processing device 1 may also acquire additional input items, screen specifications, or screen transition diagrams entered on the input screen. The details of the input screen will be described below.

The management information storage DB3 stores management information. The management information corresponds to information managed by the user, for example, past deliverables created by the user in the past. The management information may include a format for creating deliverables. The management information may correspond to information managed by an administrator as described below. The information processing device 1 instructs the management information storage DB3 to search for rights information on the basis of the designation of the past deliverables acquired from the user terminal 2. The information processing device 1 acquires management information in response to the search instructions.

For example, a retrieval augmented generation (RAG) mechanism can be used for the management information storage DB3. The RAG corresponds to a mechanism to respond to questions about contents not included in the LLM training data, such as internal company information, for example. The RAG corresponds to a technology that improves the accuracy of responses by searching internal databases and other sources for training data needed for responses and including it in prompts to the LLM. The prompts are directed to instructions or questions entered by the user of the LLM 4 in a dialog with the LLM 4 or in an interactive system such as a command line interface (CLI).

The information processing device 1 analyzes the format of the past deliverables contained in the acquired management information. The analysis of the format corresponds to the analysis of the description items and the expression format of the description items contained in the past deliverables. As mentioned above, in the waterfall system development, deliverables in the downstream development steps are created on the basis of the descriptions in the past deliverables created in the past in the upstream development steps. Accordingly, to create a new deliverable, the description of the past deliverables created in the upstream development steps and the format information that serves as a model for the creation of new deliverables are needed. The analysis of the format of the past deliverables contained in the acquired management information allows the information processing device 1 to acquire the information needed to generate new deliverables.

The information processing device 1 generates prompts for automatically generating new deliverables on the basis of the format of the retrieved past deliverables and the input items entered on the input screen, and provides them to the LLM 4.

The information processing device 1 acquires new deliverables generated by the LLM 4 in response to the prompts provided to the LLM 4. The information processing device 1 provides the new deliverables acquired from the LLM 4 to the user terminal 2.

The LLM 4 is a type of generative artificial intelligence (Generative AI) specialized for text generation and uses large amounts of text data as training data. Since the training data that the LLM 4 learns is acquired from various sources such as information that exists on the web, it may contain inaccurate information, and the responses generated on the basis of the inaccurate information may be inaccurate as well. The LLM 4 may also generate inaccurate responses by inferring unknown, unlearned information from the training data. On the other hand, management information is stored in the management information storage DB3. The management information corresponds to information managed by an administrator. The administrator may organize, add, modify or delete management information. The administrator may be directed to, for example, the administrator of the information processing device 1 or the administrator of the management information storage DB3. The administrator of the management information storage DB3 may be a user. For the management information, the administrator manages the contents of the information. The contents of the information may include, for example, the accuracy of the information, the newness of the information, the details of the information, or the usefulness of the information. The management information storage DB3 can store only management information in which the contents of the information are managed. Generating prompts that include the management information in which the contents of the information are managed and providing them to the LLM 4 allow the LLM 4 to generate accurate and useful deliverables for system development.

In this embodiment, the case in which the information processing device 1 causes the LLM 4 to generate new deliverables is illustrated, but the information processing device 1 may also provide prompts to configurations other than the LLM 4. For example, the information processing device 1 may provide prompts to an internal processor (not shown) to acquire new deliverables. The information processing device 1 may also provide prompts to multiple external devices (not shown) to acquire new deliverables from each of them.

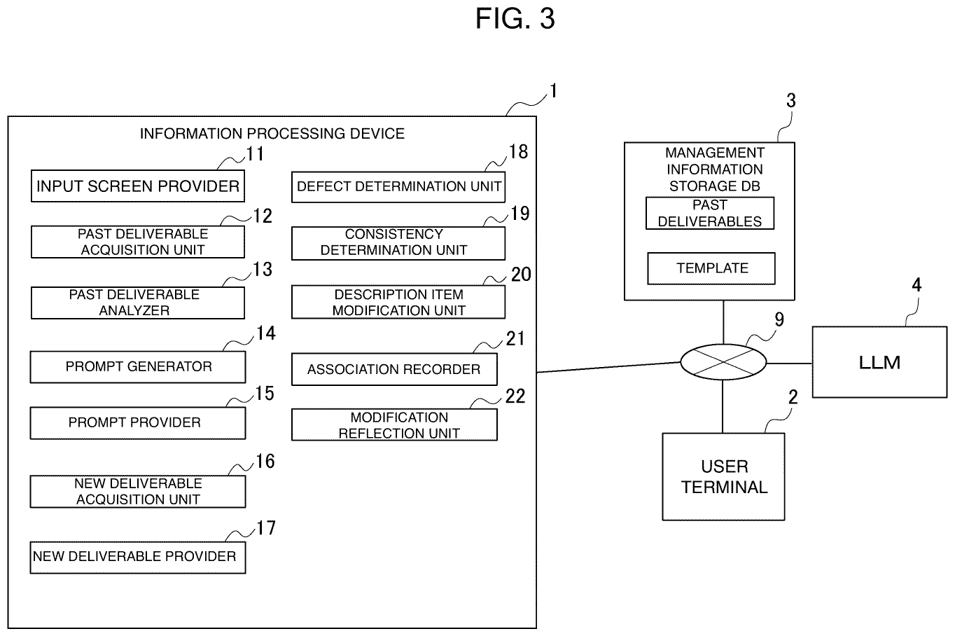

Next, with reference to FIG. 3, the configuration of the information processing device 1 will be described. FIG. 3 shows a diagram illustrating an example of the configuration of the information processing device 1 according to the embodiment.

In FIG. 3, the information processing device 1 is communicatively connected to the user terminal 2, the management information storage DB3, and the LLM 4 via the network 9. The information processing device 1 has the following functional units: input screen provider 11, past deliverable acquisition unit 12, past deliverable analyzer 13, prompt generator 14, prompt provider 15, new deliverable acquisition unit 16, new deliverable provider 17, defect determination unit 18, consistency determination unit 19, description modification unit 20, association recorder 21 and modification reflection unit 22. The functional units of the information processing device 1 according to the embodiment above are described as functional modules embodied by the information processing program (software) according to the embodiment.

The input screen provider 11 provides an input screen for entering input items needed to create a new deliverable. The details of the input screen will be described below.

The past deliverable acquisition unit 12 acquires past deliverables created in the past in the system development that includes multiple development steps (sometimes referred to as “development processes”). The past deliverables may be acquired from the management information storage DB3 or from the user terminal 2.

The past deliverable acquisition unit 12 may acquire past deliverables created in any of the development steps in the waterfall system development, and the input screen provider 11 may provide, on the basis of the past deliverables acquired in the past deliverable acquisition unit 12, an input screen for creating new deliverables in the development steps downstream from the development steps in which the acquired past deliverables were created. That is, the past deliverables acquisition unit 12 can acquire past deliverables created in the development steps upstream from the new deliverables. The input screen for creating a new deliverable corresponds to a screen for entering the information needed to create a new deliverable.

The past deliverable analyzer 13 analyzes a format of the past deliverables acquired in the past deliverable acquisition unit 12. The past deliverables analyzed by the past deliverable analyzer 13 may be deliverables created in any development step. Analyzing the format of the past deliverables allows the format of the past deliverables to be applied to new deliverables.

The prompt generator 14 generates prompts for automatically generating new deliverables on the basis of the format of the past deliverables analyzed by the past deliverable analyzer 13 and the input items entered on the input screen provided by the input screen provider 11. The prompts may contain image data in addition to text data.

The prompt provider 15 provides the prompts generated in the prompt generator 14 to the LLM 4. The new deliverable acquisition unit 16 acquires new deliverables generated in response to the prompts provided by the prompt provider 15 from the LLM 4. The new deliverable provider 17 provides the new deliverables acquired in the new deliverable acquisition unit 16 to the user terminal 2.

The defect determination unit 18 determines defects in the input items entered on the input screen provided by the input screen provider 11 on the basis of the new deliverables acquired by the new deliverable acquisition unit 16. The defects in the input items may correspond to missing or incorrectly entered items, for example. The LLM 4 may respond with an error message stating that a new deliverable cannot be generated if defects are found in the input items contained in the entered prompts. The defect determination unit 18 determines whether the acquired new deliverables contain error messages, thereby prompting the user to correct the input items.

The consistency determination unit 19 determines the consistency among multiple descriptions in the new deliverables acquired by the new deliverable acquisition unit 16. The description modification unit 20 modifies the multiple descriptions in the new deliverable on the basis of the consistency determined by the consistency determination unit 19. The consistency among multiple descriptions in the new deliverables may be directed to, for example, the presence or absence of discrepancies among multiple descriptions, or the presence or absence of fluctuations in expression (inconsistent wording).

The association recorder 21 records the association between the new deliverables generated in each of the multiple development steps, acquired by the new deliverable acquisition unit 16. On the basis of the association recorded by the association recorder 21, the modification reflection unit 22 is capable of reflecting modifications in new deliverables generated in any of the development steps on new deliverables generated in the other development steps. For the modification reflection unit 22, the AI (LLM 4) may identify new deliverables generated in the other development steps that are effected by the changes in the new deliverables generated in any of the development steps on the basis of the association recorded by the association recorder 21, and reflect the modifications on the new deliverables generated in the other development steps. In the waterfall system development, as described above, the descriptions in the deliverables created in the upstream development steps are reflected on the deliverables created in the downstream development steps. Accordingly, when multiple deliverables created in multiple development steps are present, the association of which deliverable (downstream step) is created on the basis of which deliverable (upstream step) may be unclear. The association recorder 21 records the association between new deliverables to clarify the association between deliverables created in the waterfall system development. On the basis of the recorded association, the modification reflection unit 22 is capable of reflecting modifications in new deliverables generated in any of the development steps on new deliverables generated in the other development steps.

The functional units of the information processing device 1 above are examples of functional units of the information processing device 1, and do not limit the functions of the information processing device 1. For example, the information processing device 1 needs not have all of the above functional units, but may have some of them. The information processing device 1 may also have functions other than those described above. For example, the information processing device 1 may have an input function to input information or an output function to report the operating status of the device by LED lamps or other means.

The above functional units of the information processing device 1 are described as being embodied by software as described above. However, at least one or more of the above functional units may be embodied by hardware.

Any of the above functional units may be implemented by dividing one functional unit into multiple functional units. The functional unit may also be implemented by integrating any two or more of the above functional units into one functional unit. The above description expresses the functions of the information processing device 1 in functional blocks, and does not indicate, for example, that each functional unit is configured by a separate program file, for example.

The information processing device 1 may correspond to a device embodied by a single casing or a system embodied by multiple devices connected via a network or other means. For example, the information processing device 1 may have some or all of its functions embodied by a virtual device such as a cloud service provided by a cloud computing system. That is, the information processing device 1 may embody at least one or more of the above functional units in other devices. The information processing device 1 may be a general-purpose computer such as a desktop PC, or a specialized device with limited functions.

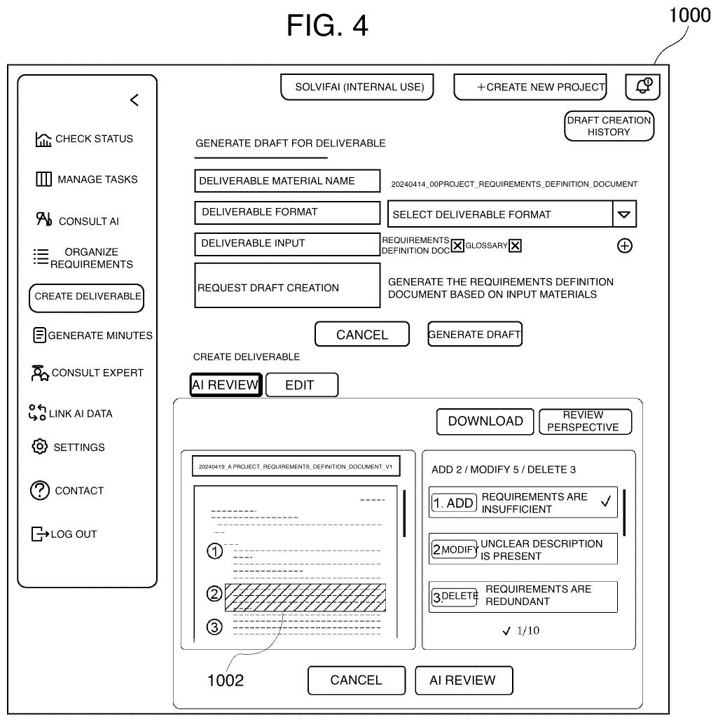

Next, with reference to FIGS. 4 through 11, the input screens provided by the input screen provider 11 will be described. FIGS. 4 through 11 show diagrams illustrating first through eighth examples of input screens for automatic generation and updating of deliverables provided by the information processing device according to the embodiment.

In FIG. 4, the input screen 1000 has a task bar illustrated on the left side of the screen. The taskbar has a “Create Deliverable” button, and the screen transitions described below are displayed when the “Create Deliverable”button is operated.

The “Draft Creation History” button allows the user to select a previously created deliverable draft (template). Selecting a draft allows for the diversion of the previously created draft.

The “Deliverable Format” button displays a pull-down menu that allows the user to select a format of the previously created deliverable. The “Deliverable Format” button allows the user to, for example, select a file format for a specific application.

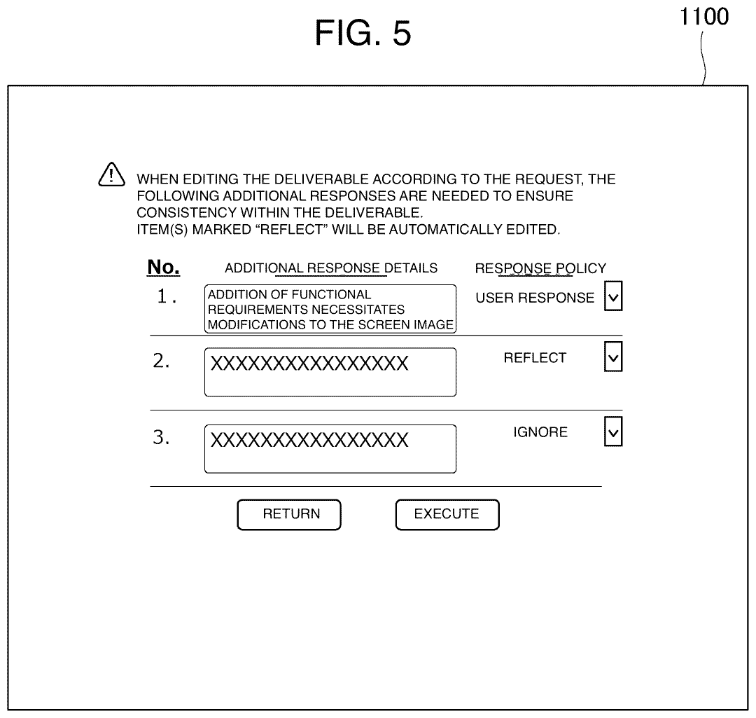

In the input screen 1100 in FIG. 5, when the image is edited (modified, changed, or deleted, for example), “User Response” is selected by default. When an image is used as an input item, the generated deliverable is often also an image, and it may often be hard to determine consistency with other deliverables. For this reason, “user response” can be selected by default to encourage the user to determine consistency. In addition, when the image is edited (modified, changed, or deleted, for example) on the input screen 1100, the user may be able to select not only the “User Response” but also the “AI Response” where the AI (LLM 4) responds in place of the user.

The “Additional Response Details” on the input screen 1100 are reflected on the prompts generated by the prompt generator 14. That is, this allows the user to instruct the LLM 4 to generate new deliverables using the past deliverables that are edited on the input screen 1100. The operation of the “Execute” button (see FIG. 5) causes a prompt to be generated and provided to the LLM 4. The description of the generated new deliverable is highlighted in the revised portion 1002 in FIG. 4.

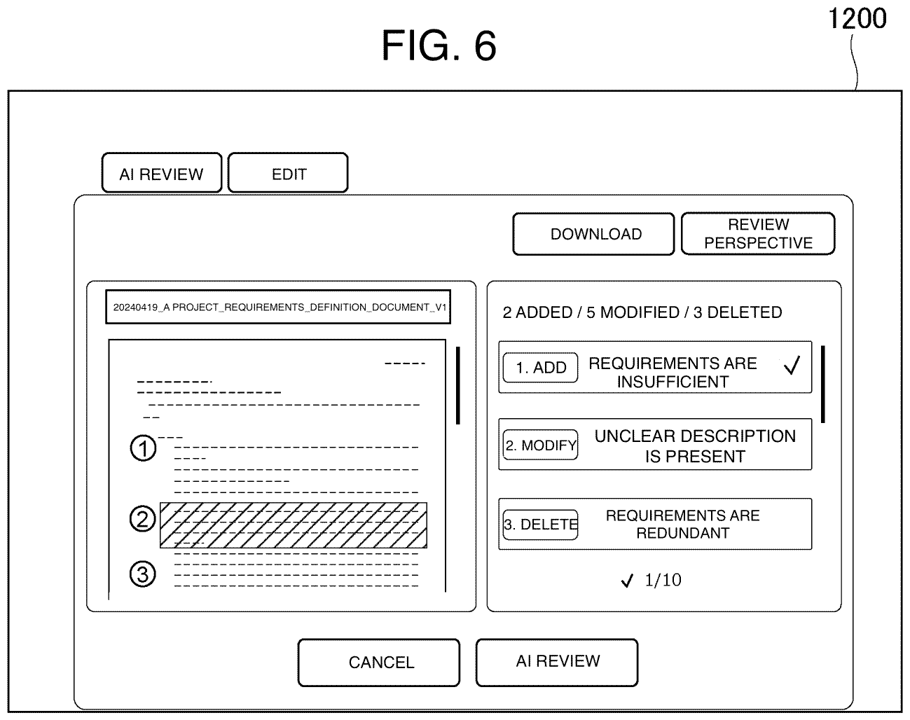

FIG. 6 illustrates the operation of AI review of deliverables on the input screen 1200. When the “Create Draft” button is operated in FIG. 4, the “AI Review” tab and the “Edit” tab are displayed. The “AI Review” tab allows input to cause new deliverables to be reviewed by the AI (LLM 4). The “Edit” tab also allows input for user review of new deliverables. The Download button is used to display the download history, to retrieve files of past deliverables that have already been downloaded, and even to retrieve files of deliverables that are currently being created (or in the process of being created).

The Review Perspective button is for registering the review perspective that the user wants the artificial intelligence (AI) to review. Various requests may be included in the prompt generation, but it is time-consuming to enter the requests each time a prompt is generated. The registration of the review perspectives to be reviewed in advance can reduce the time and effort needed to enter the requested items.

The input screen 1200 displays a display area for the name of the material entered to generate the prompt and a confirmation of its contents. The input screen shows an example of generating a requirements definition document as a new deliverable.

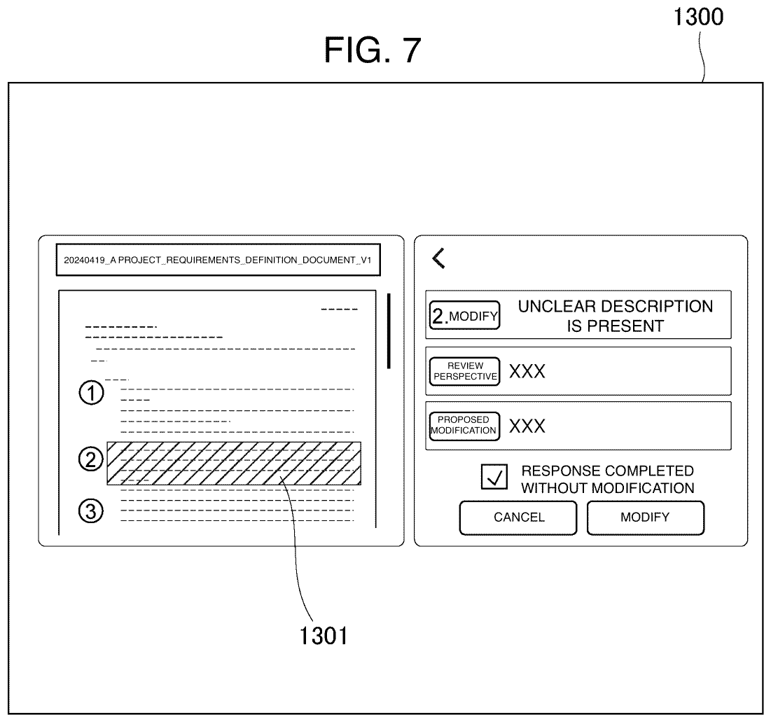

The input screen 1200 is numbered and displayed for each review perspective registered for the Review Perspective button. The highlighted portion shows the review perspective of the number selected by the user in FIG. 7.

The input screen 1200 displays the contents of the review by the AI and the total number of cases. The review contents (review results) are categorized as “Add,” “Modify,” or “Delete.” The “Add” indicates that an input item is missing and needs to be added. The “Modify” indicates that the input item needs to be modified. In addition, the “Delete” indicates that the input item needs to be deleted.

To modify the review contents, operate the “Modify” button. By operating the “Modify” button, the input screen for modifying the review contents shown in FIG. 7 is displayed.

In FIG. 7, the input screen 1300 displays the review contents. The portion corresponding to the review contents is indicated with a marker display 1301. In FIG. 7, the review contents are indicated as “Unclear description is present.”

The input screen 1300 also displays the contents of the review perspectives registered for the Review Perspective button (indicated by “XXX” for convenience in FIG. 7). In addition, the input screen 1300 displays the proposed modifications to the review contents (proposed modifications to the requirements definition document).

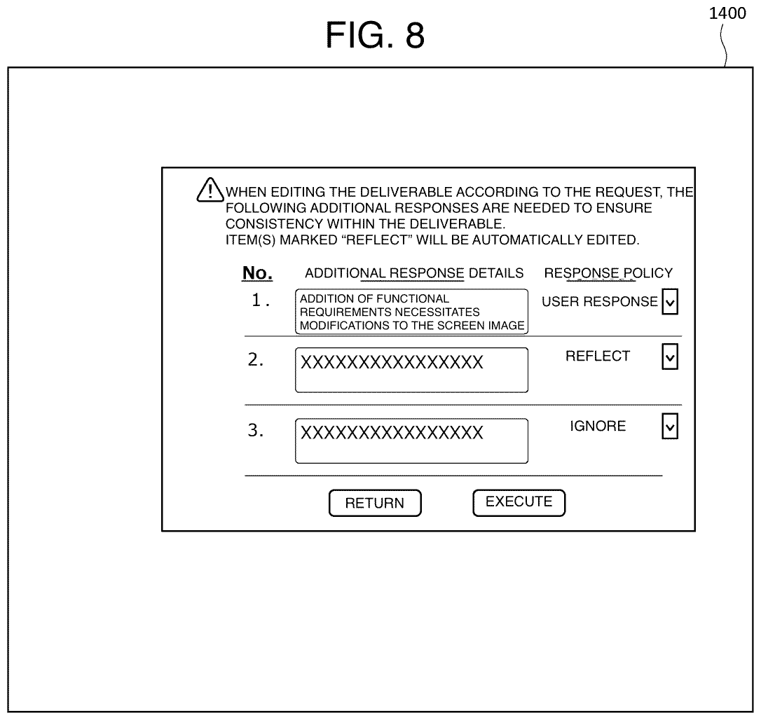

If the user determines that the modifications are not needed, the user checks the “Response Completed without Modification” checkbox. In contrast, the user operates the “Modify” button if the modifications are performed. If it is determined here that the modifications need to be consistent with other deliverables, the input screen shown in FIG. 8 is displayed.

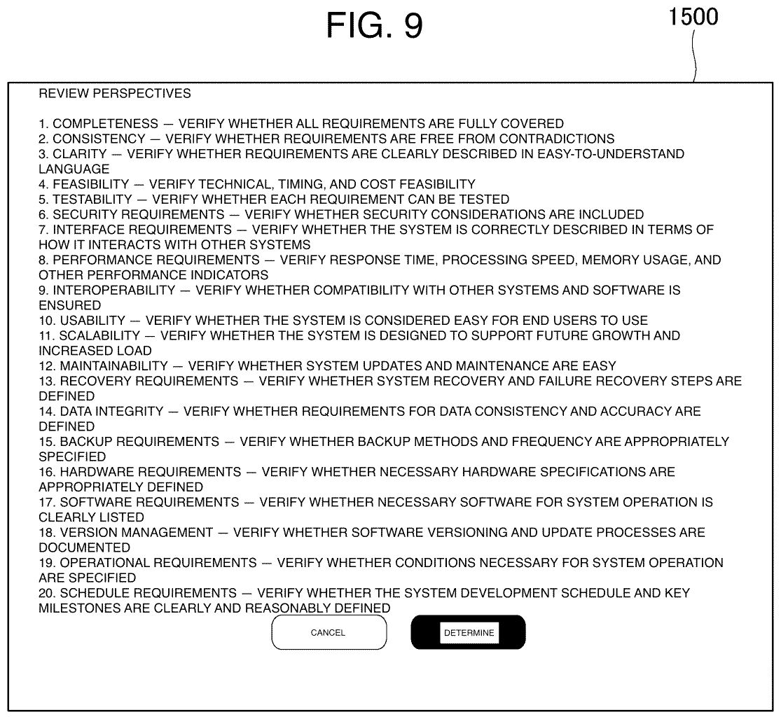

In FIG. 8, the input screen 1400 displays the review contents in an editable manner. The user may perform modifications consistent with other deliverables in accordance with the review contents. FIG. 8 shows that when modifications are performed to add functional requirements in the requirements definition document, the screen image needs to be changed in other deliverables. The input screen 1400 in FIG. 8 is the same as the input screen 1100 in FIG. 5 in the AI review function, and both play the same role. In addition, in the same manner as in the input screen 1100 in FIG. 5, when the image is edited (modified, changed, or deleted, for example) on the input screen 1400, the user may be able to select not only the “User Response” but also the “AI Response” where the AI (LLM 4) responds in place of the user. The user is capable of modifying the screen image in accordance with the review contents, thereby facilitating achieving mutual consistency between the past and new deliverables. When the “Execute” button is operated, the input items are modified. When a requirements definition document as a new deliverable is modified in response to the review contents, the color of the badge of the review contents is changed and a check mark is added to the right side of the review contents on the input screen 1200 in FIG. 6. The operation of the “AI Review” button on the input screen 1200 causes the AI review described above to be performed at any time point on the basis of the review perspective stored for the “Review Perspective” button. With reference to FIG. 9, an example of stored review perspectives will be described.

In FIG. 9, the input screen 1500 displays a list of stored review perspectives. Each review perspective may be directly editable by the user. The review perspectives are stored in advance at the initial state of the information processing device 1, and each user or each company using the information processing device 1 may be able to modify the review perspectives. In the LLM 4, the more specific the prompt to the LLM 4 is, the more accurate the response from the LLM 4 is. Displaying an editable list of reviews of deliverables allows the user to easily improve the accuracy of their reviews of deliverables. The operation of the “Determine” button causes the review perspective to be saved.

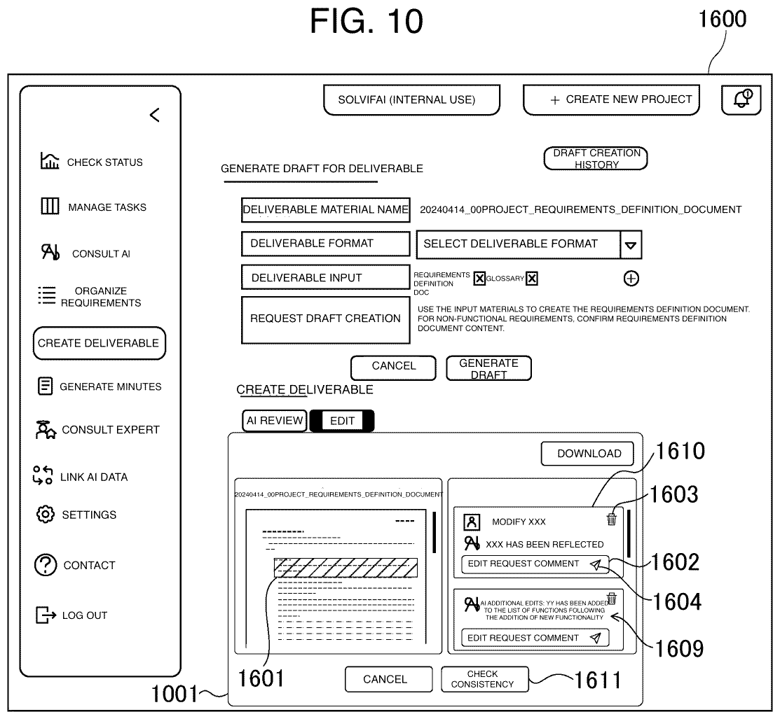

FIG. 10 shows the input screen 1600 at a time when the “Edit” tab is displayed. In FIG. 10, the input screen 1600 allows the user to edit the requirements definition document as an example of a deliverable.

In FIG. 10, the user selects the text to be edited from the items of the requirements definition document displayed on the input screen 1600. The selected text is marked with a marker 1601. When the text to be edited is selected, a comment entry field 1602 is displayed on the right side of the selected text, thereby allowing the user to enter any comment. Pressing the trash can icon 1603 causes the comment frame 1610 including the comment entry field 1602 to be deleted. For the contents of the edit request (e.g., please modify XXX) entered by the user in the comment entry field 1602, after pressing the input button 1604, the deliverable is modified by the AI (LLM 4) on the basis of the contents of the edit request. When the Check Consistency button 1611 is pressed, the input screen 1700 for consistency in the deliverable is popped up, and then the modifications are reflected on the deliverables by pressing the Execute button 1608. The deliverables are highlighted in all areas where the modifications are reflected. The additional edits performed by the AI (LLM 4) are displayed as additional edit comments 1609 by the AI.

An additional response policy 1605 for consistency within the deliverable may be available from a pull-down menu (not shown) with three options: reflect/user response/ignore. If the content of the additional response corresponds to a change of the screen image 1606, the user response is automatically selected as the response policy, but the user may also be able to select “AI Response”where the AI (LLM 4) responds in place of the user.

The content 1607 of the additional response is entered into the AI (LLM 4) as a prompt. The content 1607 of the additional response can be edited by the user.

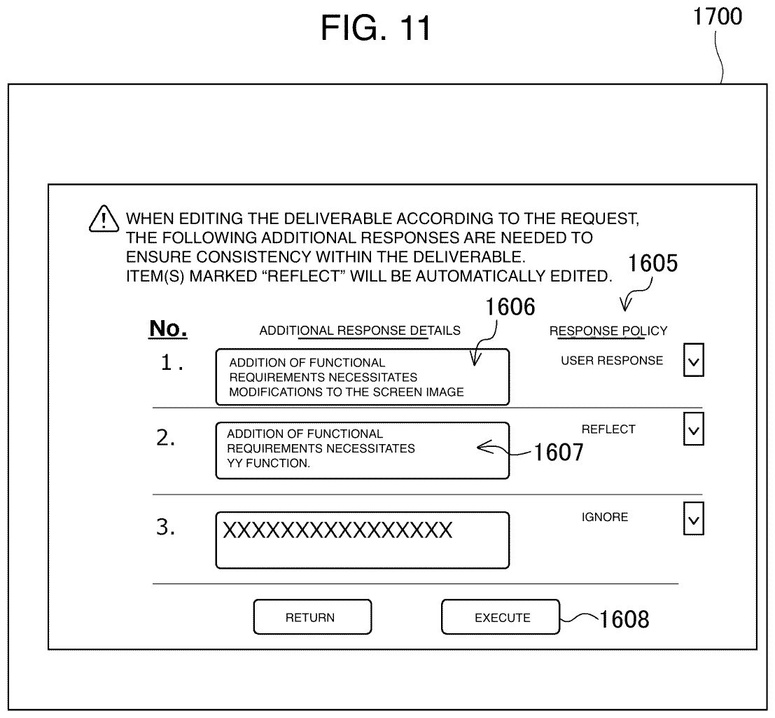

When the consistency within or between deliverables needs to be checked, operating the consistency check button 1611 displays the input screen 1700 for consistency shown in FIG. 11. In FIG. 11, the input screen 1700 has the same function as the input screen 1400 described with reference to FIG. 8. That is, when the “Edit” tab is selected, the user can directly edit the deliverable without the AI review. In this case, also, the consistency between the past and new deliverables is checked and the new deliverables are displayed as editable. This allows the user to easily create new deliverables.

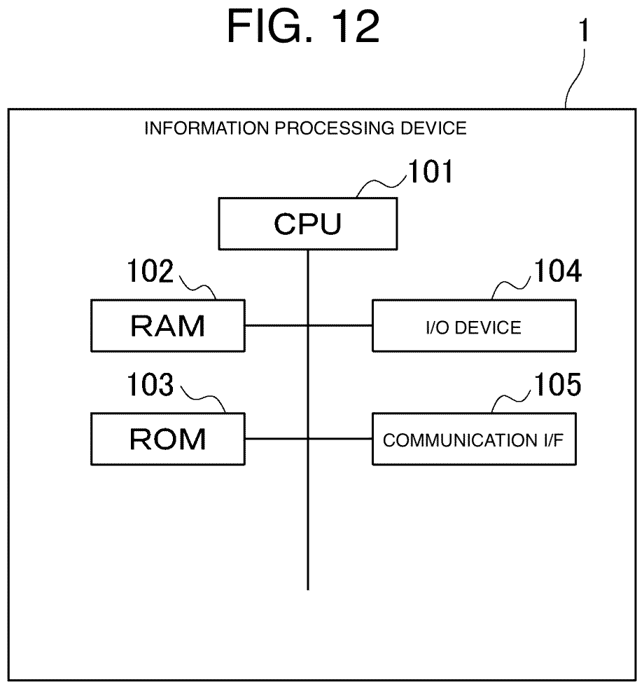

Next, with reference to FIG. 12, the hardware configuration of the information processing device 1 will be described. FIG. 12 shows a block diagram illustrating an example of a hardware configuration of the information processing device according to the embodiment.

The information processing device 1 includes a central processing unit (CPU) 101, random access memory (RAM) 102, read only memory (ROM) 103, input/output (I/O) device 104, and communication interface (I/F) 105.

The CPU 101 controls the information processing device 1 by executing the information processing program stored in the RAM 102 or ROM 103. The information processing program is obtained, for example, from a recording medium containing the program or a program distribution server via a network, installed in the ROM 103, and read and executed by the CPU 101.

The I/O device 104 has an operation input function and a display function (operation display function). The I/O device 104 may correspond to, for example, a touch panel. The touch panel enables the user of the information processing device 1 to input operations using a fingertip or touch pen, for example. The case in which a touch panel with an operation display function is used for the I/O device 104 in this embodiment is described, but the I/O device 104 may have a separate display device with a display function and an operation input device with an operation input function. In such a case, the display screen of the touch panel can be implemented as the display screen of the display device, and the operation of the touch panel as the operation of the operation input device. The I/O device 104 may be embodied in various forms such as head-mounted, eyeglass, or wristwatch type displays.

The communication I/F 105 corresponds to an interface I/F for communication. The communication I/F 105 executes short-range wireless communication such as wireless LAN, wired LAN, and infrared, for example. Although FIG. 12 illustrates only the communication I/F 105 as the I/F for communication, the information processing device 1 may have I/Fs for each communication in multiple communication methods.

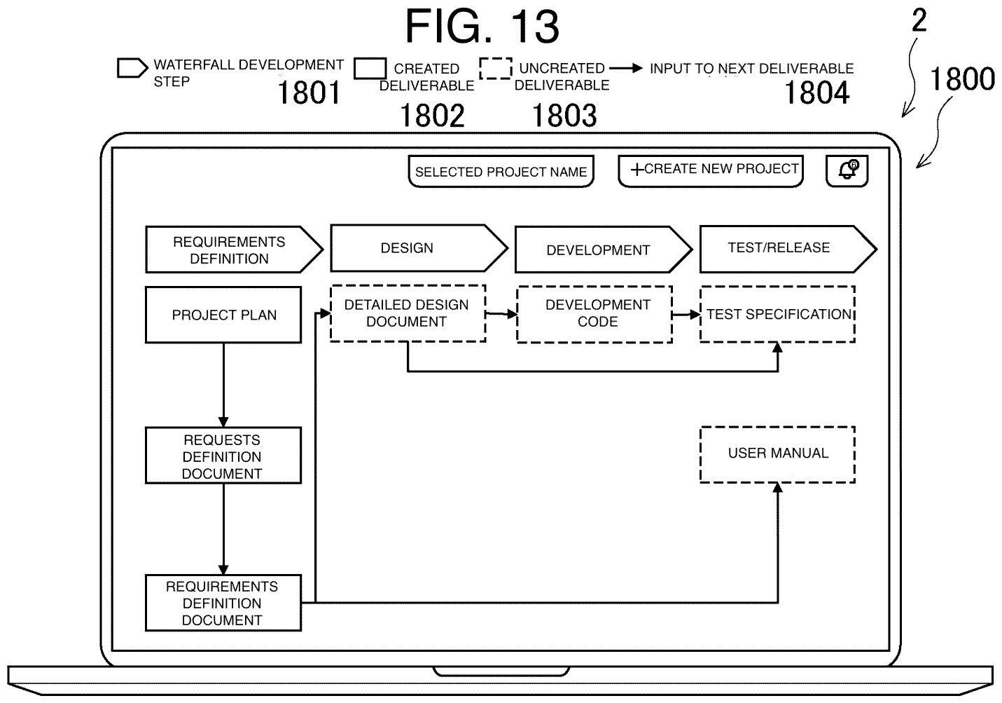

Next, with reference to FIG. 13, a centralized management function for the deliverables of the information processing device 1 will be described.

FIG. 13 shows a diagram illustrating an example of a management screen 1800 for centralized management of deliverables provided by the information processing device 1 to the user terminal 2.

The information processing device 1 (input screen provider 11) provides a management screen 1800 that displays the deliverables created in multiple development steps included in the waterfall system development for each development step. That is, the information processing device 1 (input screen provider 11) provides the management screen 1800 to the user terminal 2, and lists the deliverables created in multiple development steps (processes) included in the waterfall system development on the management screen 1800. The management screen 1800 displays the waterfall development steps 1801, the created deliverables 1802, the uncreated deliverables 1803, and the direction 1804 of inputs to the next deliverable, for example.

The direction 1804 of the input to the next deliverable indicates the direction of the deliverable connection. For example, the direction 1804 of the input to the next deliverable shown in FIG. 13 indicates that the requirements definition document is created on the basis of the project plan, the requirements definition document is created on the basis of the requests definition document, the detailed design document and user manual are created on the basis of the requirements definition document, the development code is created on the basis of the detailed design document, and the test specification is created on the basis of the detailed design document and development code. That is, the direction 1804 of the input to the next deliverable indicates the destination (direction of flow) where the information contained in the deliverable is diverted to the next deliverable.

The information on the connections between the deliverables is registered in advance in the information processing device 1 in the initial state, and at the beginning of the operation of the information processing device 1, the associations of the deliverables generated are performed on the basis of this information. In the operation of the information processing device 1, the user changes the existing registration information on the connections between the deliverables in accordance with the own preferences of the user or as needed.

The deliverables shown in FIG. 13 are only one example and are not limited to this, and various other deliverables may be applied.

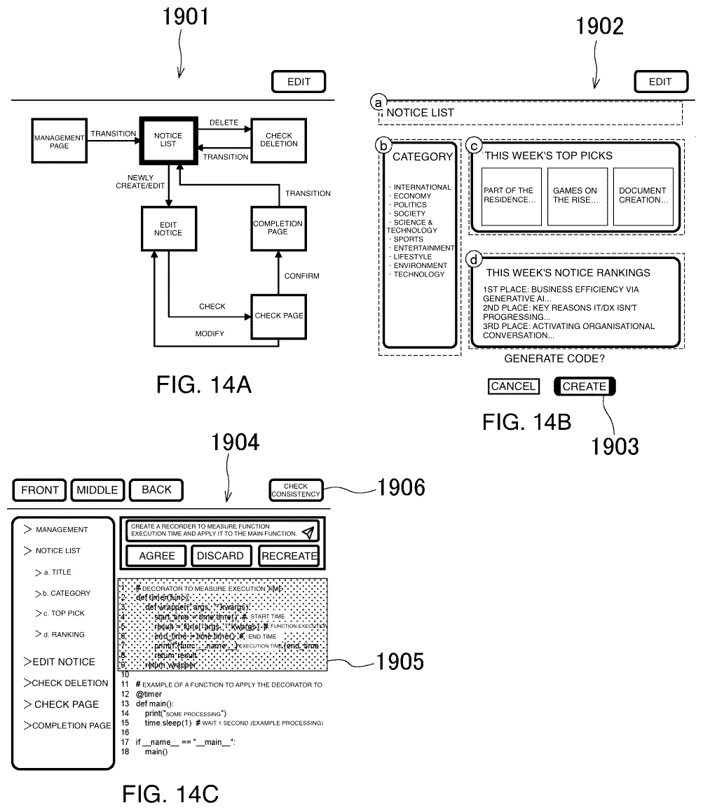

Next, with reference to FIGS. 14A through 14C, a case in which the information processing device 1 creates a programming code as a deliverable will be described.

FIGS. 14A through 14C each show a diagram illustrating a case where the information processing device 1 creates a programming code as a deliverable.

The information processing device 1 (new deliverable acquisition unit 16) acquires at least one of the materials and programming codes generated in response to the prompt generated by the prompt generator 14 from the large language model as a new deliverable.

FIG. 14A illustrates an example of a screen transition diagram 1901 loaded into the AI (LLM 4) utilizing multimodal. The multimodal refers to causing the AI (LLM 4) to understand a combination of two or more different types of data such as texts, audio, images, and videos.

FIG. 14B shows an example of a screen detail diagram 1902 loaded into the AI (LLM 4) utilizing multimodal.

The user reviews the screen transition diagram 1901 shown in FIG. 14A and the screen detail diagram 1902 shown in FIG. 14B and instructs the AI (LLM 4) to load text/voice/additional materials for correction as needed.

When the user then presses the Create Code button 1903, the prompt generator 14 creates a prompt for the AI (LLM 4) to proceed with coding. The prompts generated by the prompt generator 14 are provided to the AI (LLM 4) by the prompt provider 15, and the AI (LLM 4) generates programming codes on the basis of the provided prompts. The generated programming code is displayed in the new code display area 1905 in FIG. 14C. After the programming code is generated, the user can indicate instruction for the code consistency support between this function and other functions by pressing the consistency check button 1906.

On the basis of the generated programming code, the information processing device 1 may create deliverables in the development steps (processes) downstream from programming: unit test, combined test, comprehensive test, and acceptance test (UAT). Further, the AI may test the programming code generated as deliverables under the test environment provided by the information processing device 1 on the basis of all the deliverables created in the unit test, combined test, comprehensive test, and acceptance test (UAT), and may also report the results of such tests to the user.

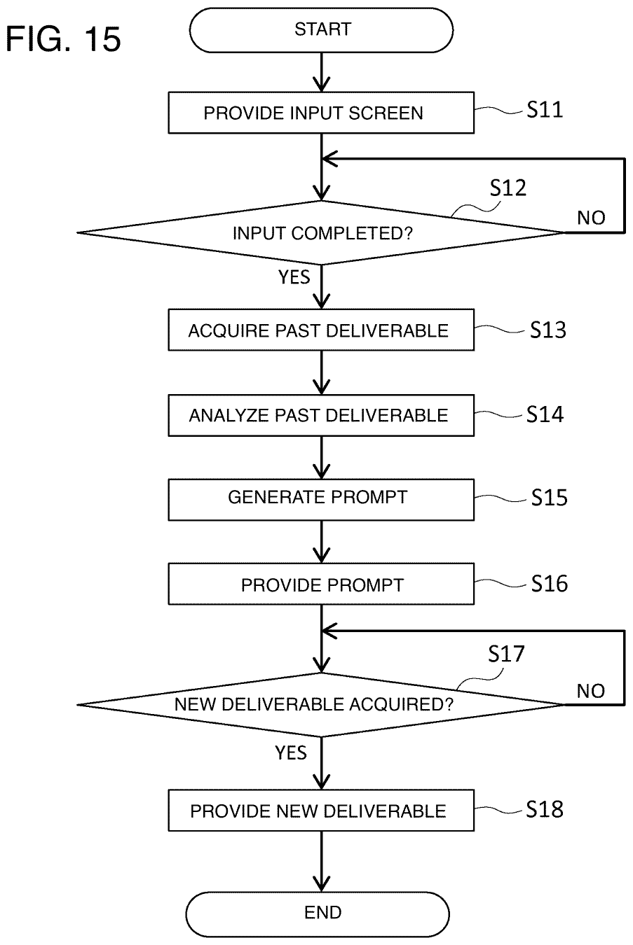

Next, with reference to FIGS. 15 through 18, the operation of the information processing device 1 will be described. FIGS. 15 through 18 are flowcharts illustrating an example of the operation of the information processing device 1 according to the embodiment. Although the information processing device 1 is described as the subject of the operations in the following flowchart, the subject of the operations may be any of the functional units of the information processing device 1 described with reference to FIG. 3.

In FIG. 15, the information processing device 1 provides an input screen (step S11). After executing the process in step S11, the information processing device 1 determines whether the input on the input screen is complete (step S12). If the information processing device 1 determines that the input on the input screen is not complete (step S12: NO), the information processing device 1 repeats the process in step S12 and waits for the input on the input screen to be completed.

In contrast, if the information processing device 1 determines that the input on the input screen is complete (step S12: YES), the information processing device 1 acquires the past deliverables specified in the input screen (step S13). After executing the process in step S13, the information processing device 1 analyzes the format of the acquired past deliverables (step S14). After executing the process in step S14, the information processing device 1 generates a prompt (step S15) and provides the prompt to the LLM 4 (step S16). After executing the process in step S16, the information processing device 1 determines whether a new deliverable has been acquired from the LLM 4 (step S17). If the information processing device 1 determines that a new deliverable has not been acquired yet (step S17: NO), the information processing device 1 repeats the process in step S17 and waits to acquire a new deliverable.

In contrast, if the information processing device 1 determines that a new deliverable has been acquired (step S17: YES), the information processing device 1 provides the acquired new deliverable to the user terminal 2 (step S18). The provision of the new deliverable can be performed, for example, by displaying it on the input screen described above in an editable manner.

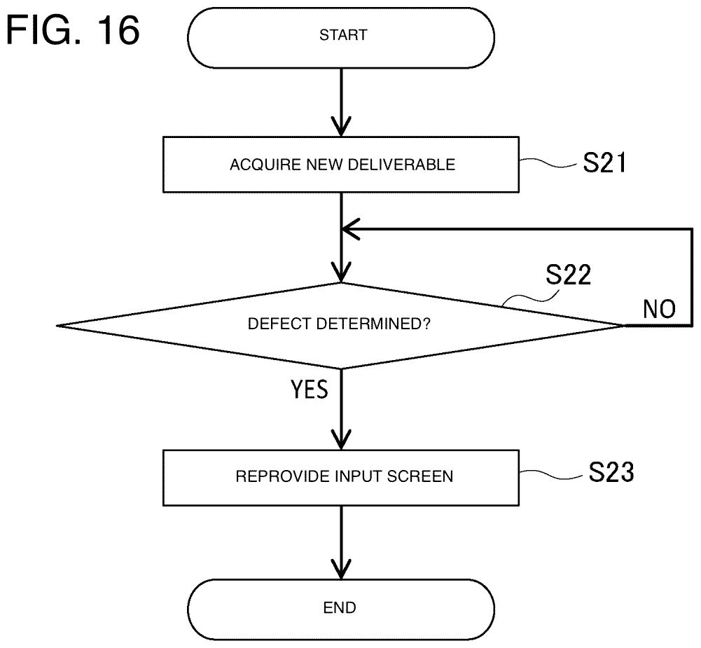

FIG. 16 illustrates the determination of the presence/absence of a defect(s) when a new deliverable is acquired as illustrated in FIG. 15. In FIG. 16, the information processing device 1 acquires a new deliverable (step S21) and determines whether to determine a defect(s) in the acquired new deliverable (step S22). The defect(s) is determined, for example, by an explicit instruction(s) from the user. If the information processing device 1 determines that the defect(s) is not determined (step S22: NO), the information processing device 1 repeats the process in step S22 and waits for an instruction to determine a defect(s). In contrast, if the information processing device 1 determines that the defect(s) is determined (step S22: YES), the information processing device 1, the result of the determination, and the portion(s) of the defect(s) are provided with an editable input screen (step S23).

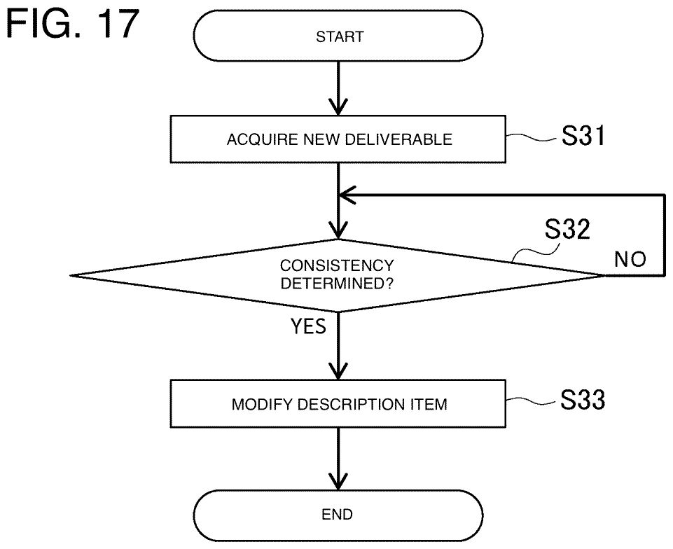

FIG. 17 illustrates the determination of the presence/absence of inconsistencies when the new deliverable illustrated in FIG. 15 is acquired. In FIG. 17, the information processing device 1 acquires a new deliverable (step S31) and determines whether to determine inconsistencies in the acquired new deliverable (step S32). The inconsistencies are determined, for example, by an explicit instruction(s) from the user. If the information processing device 1 determines that the inconsistencies are not determined (step S32: NO), the information processing device 1 repeats the process in step S32 and waits for an instruction to determine the inconsistencies. In contrast, if the information processing device 1 determines that the inconsistencies are determined (step S32: YES), the information processing device 1 provides the determination result and the portion(s) of the defect(s) with an editable input screen (step S33).

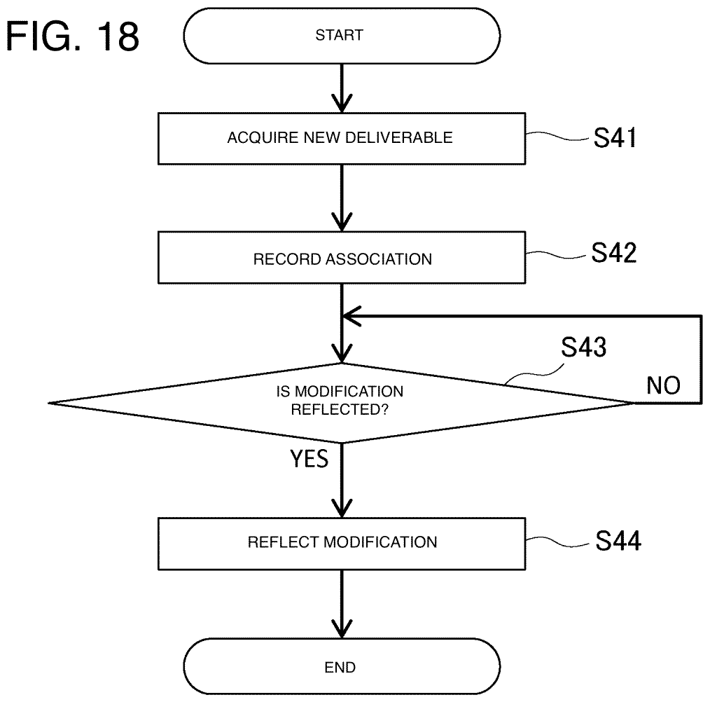

FIG. 18 illustrates the modification of past deliverables associated with the new deliverable when the new deliverable illustrated in FIG. 15 is acquired. In FIG. 18, the information processing device 1 acquires a new deliverable (step S41) and records the association of the new deliverable with the past deliverables (step S42). For example, if a new deliverable is generated on the basis of a past deliverable created in an upstream development step, record the association of the new deliverable with the past deliverable from which the new deliverable has been generated. The record of association may, for example, record which description items of the deliverables are associated. After executing the process in step S42, the information processing device 1 determines whether an instruction is performed to reflect the modifications in the description items of the new deliverable on the past deliverables (step S43). If the information processing device 1 determines that the instruction has not been performed to reflect the modification (step S43: NO), the information processing device 1 repeats the process in step S43 and waits for an instruction to reflect the modification.

In contrast, if the information processing device 1 determines that the instruction has been performed to reflect the modification (step S43: YES), the information processing device 1 reflects the modified portions on the associated past deliverables (step S44).

The operation shown in the flowchart above is an example of the operation of the information processing device 1 and does not limit the order of processing. For example, specific processes may be performed in a different order or at a different time points than the order of the processes in the flowchart.

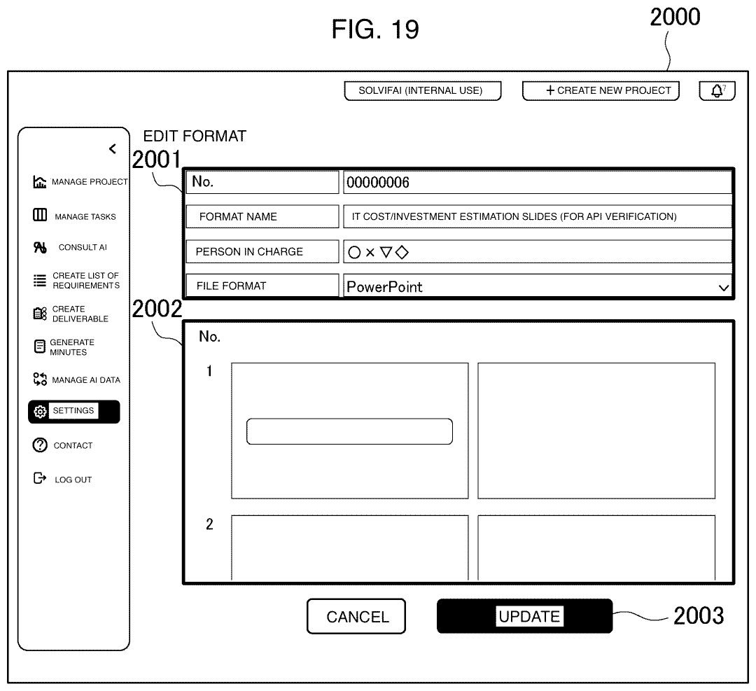

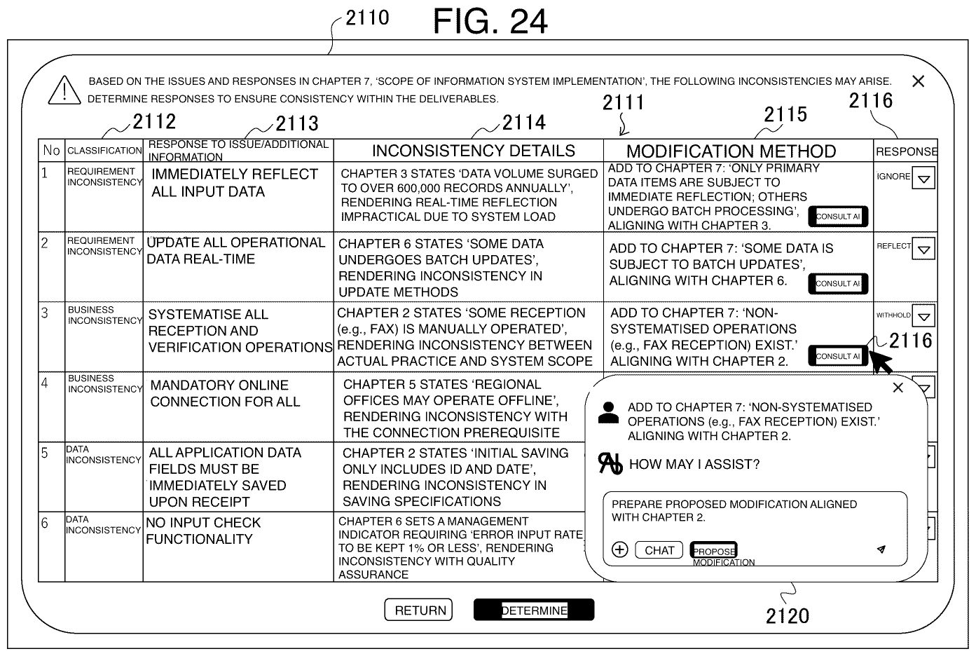

For the Information Processing Device 10 according to the Second Embodiment With reference to FIGS. 19 through 32, the information processing device 10 according to the second embodiment of the present disclosure will be described in detail. In these drawings, the same or corresponding portions may be assigned with the same reference numerals and redundant descriptions may be omitted. In all the drawings, selected components are shown to illustrate the present disclosure, and other components may be omitted. Further, the present disclosure is not limited to the second embodiment described below. The contents contained in multiple drawings may be omitted to avoid redundant descriptions.

The information processing device 10 according to the second embodiment differs in that the input screens provided during automatic generation and updating of deliverables use the ninth to twenty-second examples shown in FIGS. 19 through 32 in place of the first to eighth examples shown in FIGS. 4 through 11 of the information processing device 1 according to the embodiment described above.

In the following description of the information processing device 10 according to the second embodiment, only the portions that differ from those of the information processing device 1 according to the embodiment above will be described, the description of the same portions as those of the information processing device 1 according to the embodiment above will be omitted with the same reference numerals, and the description of the information processing apparatus 1 according to the embodiment above will be applied.

With reference to FIGS. 19 through 32, ninth to twenty-second examples of the input screens provided by the input screen provider 11 will be described. FIGS. 19 through 32 show diagrams illustrating ninth through twenty-second examples of input screens for automatic generation and updating of deliverables provided by the information processing device 10 according to the second embodiment.

Two main use cases are present for the automatic generation and updating of deliverables of the information processing device 10.

In the first use case, the information processing device 10 generates a draft (initial draft) of the deliverable (AI draft), edits the generated draft of the deliverable (AI edit), and reviews the quality of the edited deliverable (AI quality review).

In the second use case, the deliverables created and edited by the user are reviewed by the information processing device 10 (AI quality review). That is, in the second use case, the information processing device 10 does not perform the AI drafting and AI editing as in the first use case.

The AI draft means that the information processing device 10 generates a draft (initial draft) of the deliverable, the AI edit means that the information processing device 10 edits the draft of the deliverable, and the AI quality review means that the information processing device 10 reviews the quality of the deliverable.

The review may also be defined as checking and evaluating the quality of the deliverables and proposing improvements.

The AI draft in the first use case mainly involves (a) registration of a template specified by the user of the information processing device 10 in advance, and (b) analysis of the inputs of the information processing device 10 and generation of deliverables as per the template.

Next, in the AI edit in the first use case, automatic modification of the deliverable of the information processing device 10 is performed mainly through (c) presentation of the portions created by the information processing device 10 in the deliverable and its reason (version management is also performed), and (d) dialogue between the user and the information processing device 10.

Next, in the AI quality review in the first use case, (e) the entire deliverable is reviewed from the perspective registered by the information processing device 10 to point out omissions in requirements consideration.

In the AI quality review in the second use case, (f) the material is uploaded by the user to the information processing device 10, and the entire deliverable is reviewed from the registered perspective of the information processing device 10 to point out any omission in requirements consideration.

### First Use Case

### (a) Registration of Template Specified by the User of the Information Processing Device 10

With reference to FIG. 19, the registration of templates specified by the user of the information processing device 10 in advance will be described. FIG. 19 shows a ninth example of an input screen for automatic generation and updating of deliverables provided by the information processing device 10 (input screen provider 11).

The user terminal 2 displays the input screen 2000 provided by the input screen provider 11.

In FIG. 19, the input screen 2000 has a taskbar illustrated on the left side of the screen. A “Settings” button is present on the taskbar, and the input screen 2000 appears when the “Settings” button is operated.

The input screen 2000 is used for registration of user-specified templates in advance.

The template is directed to a model of the deliverables to be generated and a predetermined style of deliverables. The AI (LLM 4) generates deliverables in accordance with the style determined by the template.

The user enters basic information on the template to be registered in advance in the basic information input area 2001 of the input screen 2000. In the basic information input area 2001, the user enters, for example, the format name of the template to be registered in advance in the format name field and the file format name of the template to be registered in advance in the file format field.

The format name refers to a name of the specific format or configuration of the template to be registered in advance, and file format name refers to a name of the recording method used to save data in a file, for example, PowerPoint (registered trademark) format.

Next, the user enters detail information on the template to be registered in advance in the detail information input area 2001 of the input screen 2000.

The detail information may include, for example, tables of contents of the deliverables to be generated, a specific method of describing the content(s) for each table of contents (contents image), and guidelines for creating contents (format, amount of output, and points to note, for example).

The guidelines for creating contents may be directed to a prompt or backprompt given to the AI (LLM 4).

The prompt is directed to an instruction or input given to the AI (LLM 4) to generate a specific response.

The back prompt is directed to an internal setting that defines instructions and rules for the AI (LLM 4) to operate, and serves to determine the behavior, output style, and prohibitions, for example, of the AI (LLM 4).

The user is allowed to set prompts or backprompts for each table of contents of the deliverable to be generated, thereby allowing the user to acquire the deliverables that faithfully reproduce the intentions or requirements of the user.

The user is also allowed to register template specified by the user in advance to avoid having to give a prompt or backprompt to the AI (LLM 4) each time a deliverable is generated.

The user can register a template specified by the user in advance by pressing the Update button 2003 on the input screen 2000. After this, the user is capable of selecting and specifying a pre-registered template when generating a draft of a deliverable to acquire a deliverable generated in accordance with the style determined by the template.

### (b) Analysis of the Inputs of the Information Processing Device 10 and Generation of Deliverables as per the Template

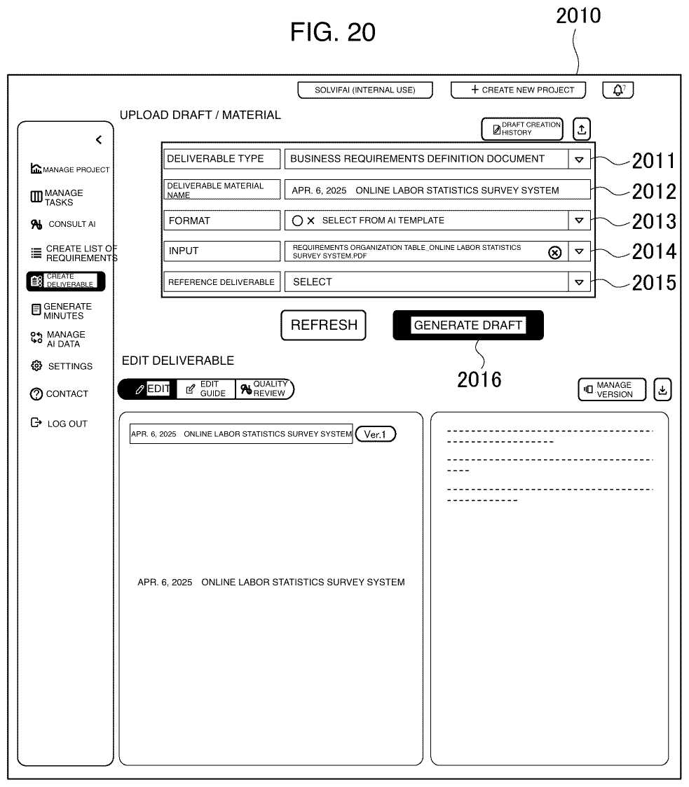

With reference to FIGS. 20 through 26C, the analysis of the inputs of the information processing device 10 and the generation of deliverables as per the template will be described. FIGS. 20 through 26C show tenth through sixteenth examples of input screens for automatic generation and updating of deliverables provided by the information processing device 10 (input screen provider 11).

The inputs correspond to the information on which the AI (LLM 4) is based when deliverables are generated, and may be referred to as input information, input data, or input materials.

First, with reference to FIG. 20, draft generation of the complete table of contents for the deliverable will be described.

The user terminal 2 displays the input screen 2010 provided by the input screen provider 11.

In FIG. 20, the input screen 2010 has a taskbar illustrated on the left side of the screen. A “Generate Deliverable” button is present on the taskbar, and the input screen 2010 appears when the “Generate Deliverable”button is operated.

The input screen 2010 is used by the user to generate a draft of the complete table of contents of the deliverable.

The user selects the type of deliverable to be generated from the deliverable types registered in advance in the pull-down menu of the deliverable type selection field 2011. The deliverable types may be the deliverables created in each development step (process) of the waterfall system development, such as proposal documents, requirements definition documents, basic design documents, detailed design documents, programming, unit test plans, comprehensive test plans, acceptance test plans, user manuals, and migration plans, for example.

Next, the user enters the name of the deliverable to be generated in free text in the deliverable material name entry field 2012. The user is allowed to set the name of the deliverable as desired.

Next, the user selects a template as a format of the deliverable to be generated from the templates of the deliverables registered in advance in the pull-down menu of the format selection field 2013. The templates of deliverables may include templates registered in advance by the user according to (a) above, and templates registered in the initial (default) state of the information processing device 10.

Next, the user selects the information that the AI (LLM 4) will use as the basis for generating deliverables from the inputs registered in advance in the pull-down menu in the input selection field 2014.

The inputs displayed in the pull-down menu in the input selection field 2014 may be files in a folder in the terminal specified by the user.

Next, the user selects the information that the AI (LLM 4) will refer to for generating the deliverables from the reference project deliverables registered in advance in the pull-down menu in the reference deliverable selection field 2015. The reference project deliverables may correspond to deliverables from past projects similar to the project for which the deliverables are to be generated.

The user may divert the deliverables generated in the past projects when the AI (LLM 4) generates deliverables.

The user is capable of allowing the AI (LLM 4) to generate a draft for deliverable by pressing the Generate button 2016, which may be displayed in the lower left window of the input screen 2010.

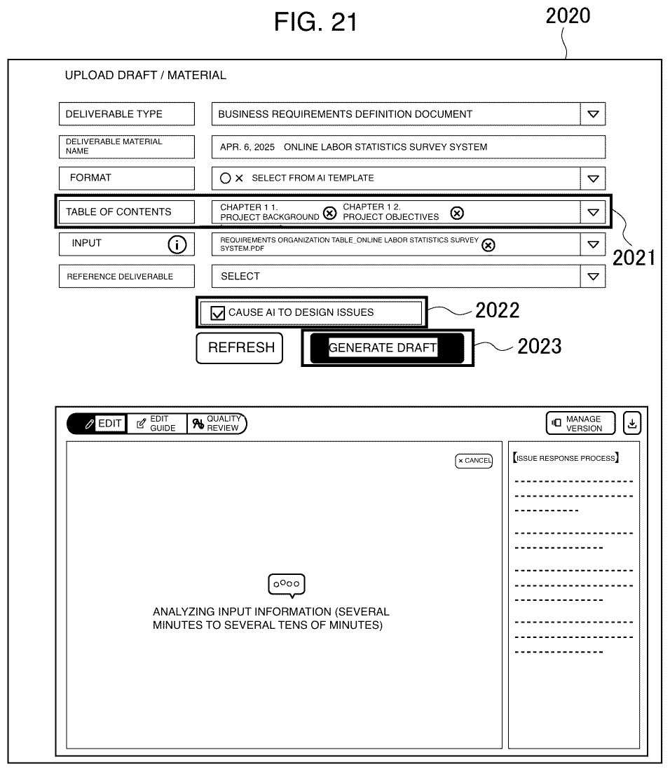

Next, with reference to FIGS. 21 through 24, the generation of a draft for deliverable by specifying a table of contents will be described.

The user terminal 2 displays the input screen 2020 provided by the input screen provider 11.

The input screen 2020 is used when the user generates a draft for deliverable by specifying a table of contents.

The operations in which the user sets a name of a deliverable document and selects a deliverable type, format, input, and reference deliverable are the same as those performed when a draft of the complete table of contents of the deliverable is generated.

The user selects, from among tables of contents of deliverables registered in advance in a pull-down menu of a table-of-contents selection field 2021, a table of contents of a deliverable to be generated. The table of contents of the deliverable registered in advance in the pull-down menu is set by selecting the format of the deliverable to be generated.

If the user checks the checkbox 2022, the AI (LLM 4) designs the issues before generating a draft for deliverable to compensate for the lack of inputs.

The issues correspond to specific contents of questions to the user to compensate for the lack of inputs, and the issue design corresponds to the generation of specific contents of questions to the user by the AI (LLM 4).

When the user presses the Generate Draft button 2023, the AI (LLM 4) analyzes the selected input data and designs the issues of the first table of contents also with reference to the guidelines for creating contents for the selected table of contents. The AI (LLM 4) may design a proposed a response to each issue at the same time that the AI (LLM 4) designs the issue, and present the proposed response along with the issue to the user.

The AI (LLM 4) may design three to five issues for each table of contents, and when designing a proposed response, it may design as many proposed responses as the number of issues to be designed.

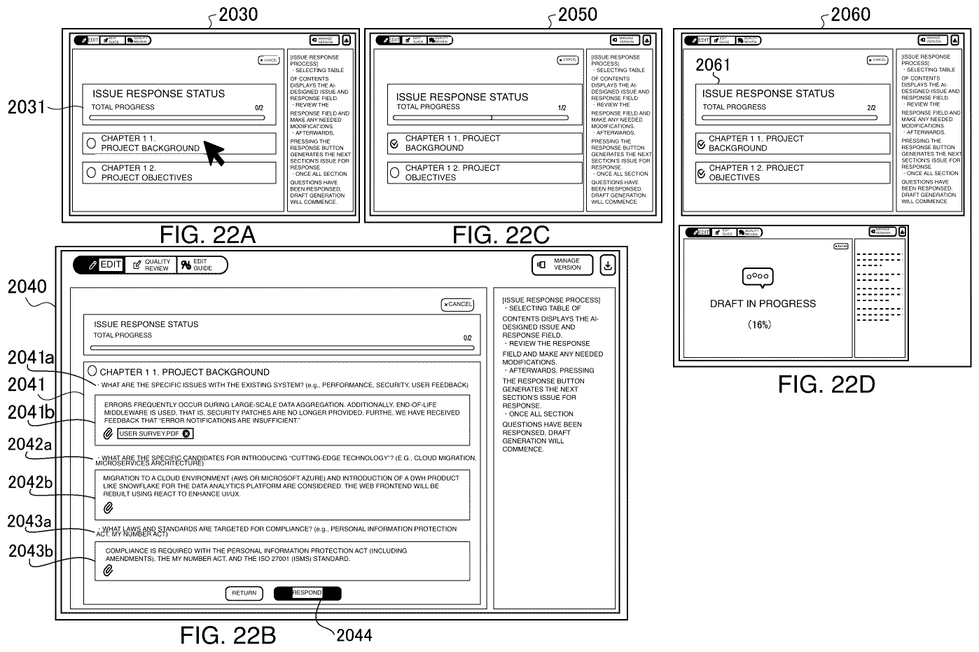

The proposed response designed by the AI (LLM 4) may be editable by the user and may even be accompanied by a reference material 2041c (see FIG. 22B) that the proposed response cites.

The AI (LLM 4) designed issues, proposed responses, and reference materials may be displayed in the lower left window of the input screen 2020. Further, the lower right window of the input screen 2020 may display the “Issue Response Process” for the user to keep in mind when responding to the issues.

With reference to FIGS. 22A through 22D, the procedure for the user to respond to the issues will be described.

The user terminal 2 displays the input screens 2030 to 2060 provided by the input screen provider 11, transitioning in accordance with the progress of the responses of the user to the issues.

When the user selects a first table of contents item (Chapter 1:1. Project Background) from among the table-of-contents response status 2031 (see FIG. 22A) displayed on the input screen 2030, issues and proposed responses designed by the AI (LLM 4) are displayed in an issue/proposed response display area 2041 of the input screen 2040 (see FIG. 22B). The table of contents response status 2031 indicates the progress of the responses of the user to the issues.

Each time a table of contents is selected by the user, the AI (LLM 4) generates prompts and designs issues and proposed responses for the table of contents selected by the user on the basis of the issues and responses of the user in the table of contents before the selected table of contents. This is because important information may be added in the table of contents before the selected table of contents, and if the issues and proposed responses in the selected table of contents are not designed with this in mind, the same questions may be asked, or inconsistency may occur among the tables of contents.

In the issue/response display area 2041, for example, a first issue 2041a, a proposed response 2041b to the first issue, and a reference material 2041c, as well as a second issue 2042a and a proposed response 2042b to the second issue, and a third issue 2043a and a proposed response 2043b to the third issue are displayed.

The cited material 2041c corresponds to a cited material for the proposed response 2041b to the first issue.

The user may respond to the issue by modifying the proposed response displayed in the proposed response display area 2041 as needed, or may delete the proposed response and enter a response optionally.

The user can respond by pressing the Respond button 2044 displayed at the bottom of the input screen 2040. In response to the pressing of the Respond button 2044 by the user, the table-of-contents response status 2031 moves the response of the user progress forward by one (see the input screen 2050 in FIG. 22C).

Next, when the user selects a second table of contents item (Chapter 1:2. Project Objective) from among the table-of-contents response status 2031 (see FIG. 22C) displayed on the input screen 2050, issues and proposed responses designed by the AI (LLM 4) for the second table of contents are displayed in an issue/proposed response display area (not shown) of the input screen 2050. When the user responds to the issue in the second table of contents and presses the Respond button (not shown), the progress status indicated by the issue response status 2061 moves forward by one (see FIG. 22D).

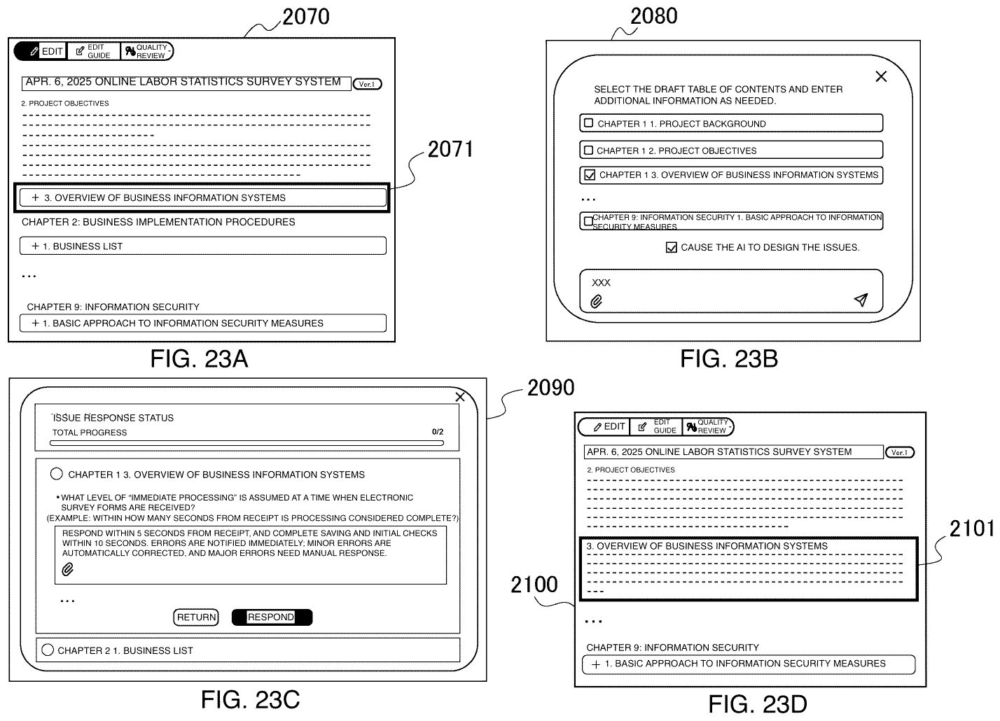

With reference to FIGS. 23A through 23D, a case in which the user responds to the issues after the drafts for deliverables have been generated will be described.

The generated drafts for deliverables are displayed on the display screen 2070 of the user terminal 2 as shown in FIG. 23A. Among the generated drafts for deliverables, the table of contents (not yet created table of contents 2071) is displayed with a “+” button at the top as shown in FIG. 23A. By clicking on the “+” button, the user is presented with a pop-up menu to select the table of contents for which she/he wishes to generate a draft for deliverable (see the input screen 2080 in FIG. 23B).

When the user selects the table of contents for which she/he wishes to generate a draft for deliverable from the pop-up menu on the input screen 2080, the input screen 2090 is displayed on the user terminal 2 if issues designed by the AI (LLM 4) are present, and the input screen 2100 is displayed on the user terminal 2 if issues designed by the AI (LLM 4) are not present.

The AI (LLM 4) prepares the issues and proposed responses for the table of contents selected by the user on the basis of the guideline for creating the content of the template selected for generating a draft for deliverable, the content of the table of contents already created, the input to date, and any additional inputs.

The user responds to the issues on the input screen 2090 displayed on the user terminal 2, and the AI (LLM 4) generates a draft of the selected table of contents consistent with the response.

If the AI (LLM 4) does not design the issues, the AI (LLM 4) generates a draft for table of contents of the deliverable selected by the user from the pop-up menu on the input screen 2080 and displays the generated draft 2101 on the input screen 2100.

The consistency determination unit 19 of the information processing device 10 checks the consistency between the data in each table of contents of the generated draft for deliverable, creates a table 2111, and displays the table 2111 on the input screen 2110.

The table 2111 represents the inconsistencies contained in the content for each table of contents, and for each inconsistency has classification column 2112, response to the issue/additional information column 2113, inconsistency content column 2114, modification method column 2115, and the association column 2116.

The classification column 2112 stores the three patterns of inconsistency classification (requirement inconsistency, business inconsistency, and data inconsistency) determined by the consistency determination unit 19 for each inconsistency.

The response to the issue/additional information column 2113 contains the content of the response to the issue that causes the inconsistency or additional information.

The inconsistency content column 2114 contains a description of where specifically the response to the issue/additional information is causing the inconsistency.

The modification method column 2115 contains the AI (LLM 4) suggestions for what should be modified on the basis of the entire requirements definition document.

The response column 2116 contains the response policy selected by the user. The response policy is selected by the user from three patterns: reflect, withhold, or ignore the modification method proposed by the AI (LLM 4).

If the user selects to reflect, the modification method proposed by the AI (LLM 4) is reflected on the draft for deliverable.

If the user selects to withhold, the modification method proposed by the AI (LLM 4) is stored in the management information storage DB3 as historical information.

If the user wishes to change the modification method suggested by the AI (LLM 4), she/he may press the Consult AI button 2117. When the Consult AI button 2117 is pressed, the input screen 2120 is displayed on the user terminal 2. The input screen 2120 provides a chat-style dialogue that provides the user with a natural written conversation with the AI (LLM 4) and returns responses, allowing the user to change the modification method by responding to the issues generated by the AI (LLM 4).

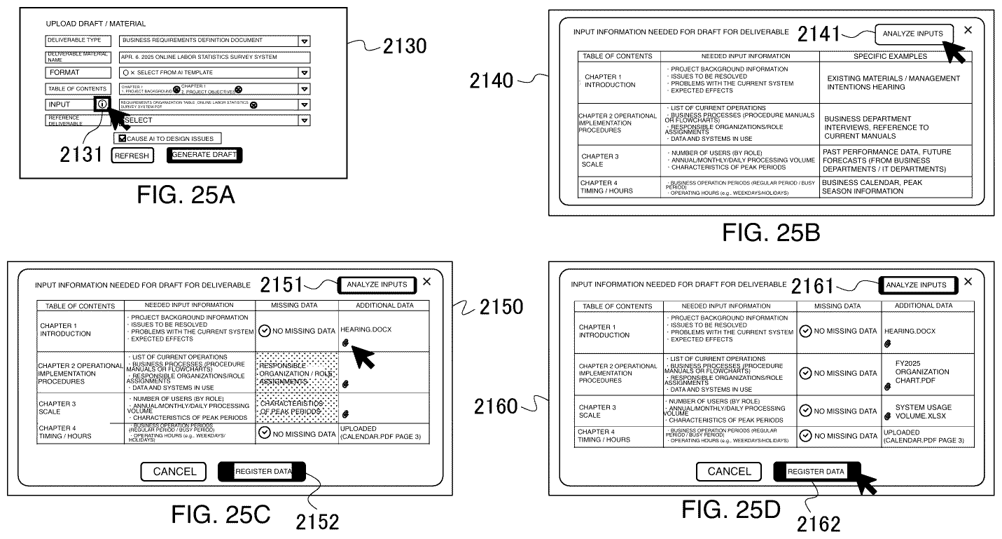

With reference to FIGS. 25A through 25D, the input analysis that the user performs as a preparation prior to the generation of a draft for deliverable will be described.

The user terminal 2 displays the input screens 2130 to 2160 provided by the input screen provider 11, transitioning in accordance with the progress of the input analysis of the user.

The input analysis is directed to the analysis of whether the AI (LLM 4) has the information needed to generate a draft for deliverable on the basis of the format selected by the user.

When the user clicks on the i-mark 2131 on the input screen 2130, the user terminal 2 transitions the display to the input screen 2140.

The input screen 2140 displays a list 2141 of needed input information and specific examples thereof for each table of contents of the draft for deliverable. When the user presses the Input Analysis button 2142 on the input screen 2140, the AI (LLM 4) analyzes the excess or deficiency of existing inputs.

The AI (LLM 4) displays the list 2152 on the input screen 2150, which corresponds to the list 2141 to which missing data column 2151 is added. The list 2152 highlights the missing data 2153.

If the user uploads the missing data 2153 in the list 2152 to the information processing device 10 and the missing information status needed to generate a draft for deliverable is resolved, the list 2152 is updated to the status of no missing data.

When the user presses the Register Data button 2161 on the input screen 2160, the additional data added by the user is registered in the input entry field 2132 on the input screen 2130.

(c) Present the Portion of the Deliverable where the AI (LLM 4) has Created and the Reason for the Creation (Version management is also implemented).

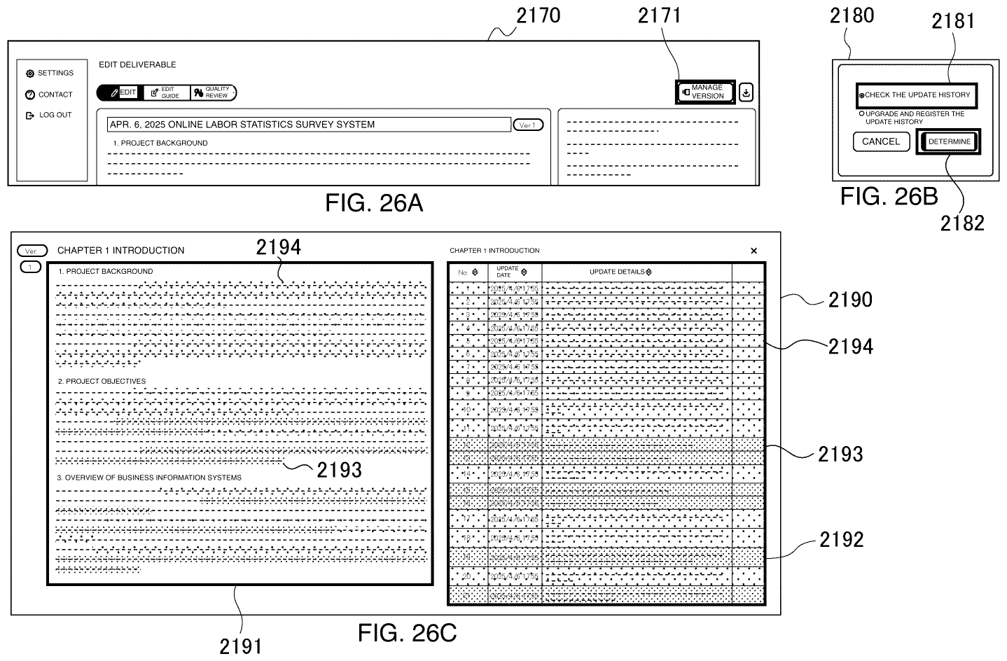

With reference to FIGS. 26A to 26C, the presentation of the AI (LLM 4) created portions in the deliverables and the reasons for their creation will be described.

The user terminal 2 transitions and displays input screens 2170 to 2190 provided by the input screen provider 11.

As shown in FIG. 26A, the input screen 2170 displays the AI (LLM 4) generated draft for deliverable.

When the user presses the Manage Version button 2171 on the input screen 2170, the display of the user terminal 2 changes to the input screen 2180 (see FIG. 26B).

When the user selects “Check Update History” 2181 on the input screen 2180 and presses the Determine button 2182, the input screen 2190 is displayed on the user terminal 2 (see FIG. 26C).

The input screen 2190 has a generated draft display area 2191 and an updated contents list display area 2192.

The generated draft display area 2191 corresponds to an area that displays the drafts for deliverables generated by the AI (LLM 4).

The update contents list display area 2192 shows a list of updates to the drafts for deliverables performed by the AI (LLM 4).

The generated draft display area 2191 and the update contents list display area 2192 highlight the AI (LLM 4) created portions 2193 and the input citation portions 2194 with a distinction therebetween. The AI (LLM) created portion 2193 corresponds to the portion of the description created by the AI (LLM 4), and input citation portion 2194 corresponds to the portion of the description by the AI (LLM 4) citing the input.

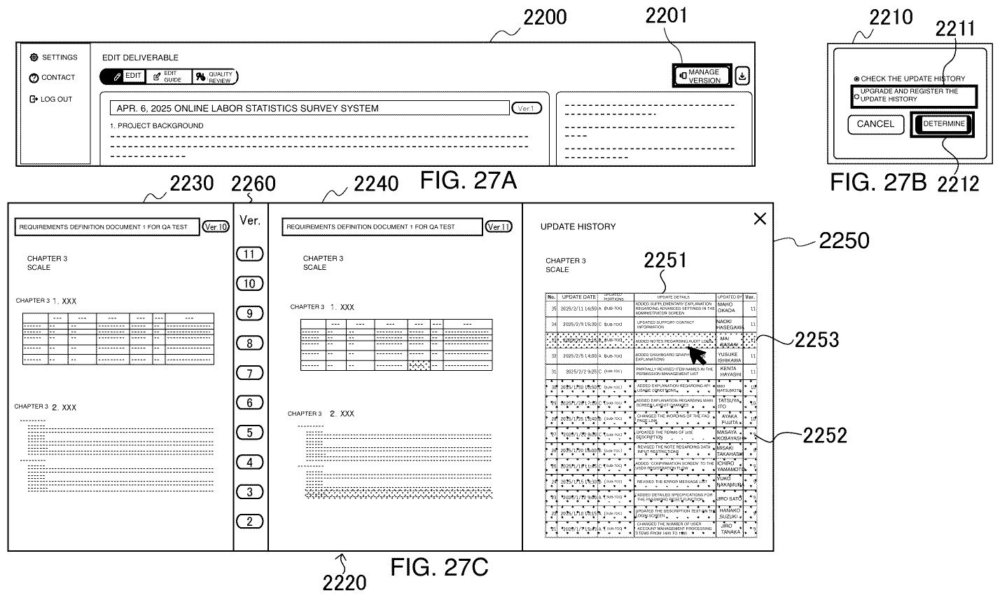

With reference to FIGS. 27A through 27C, version management of deliverables will be described.

The version management of deliverables is directed to the function of recording the status (state) and change history of deliverables.

The user terminal 2 transitions and displays the input screens 2200 to 2220 provided by the input screen provider 11.

As shown in FIG. 27A, the input screen 2200 displays the AI (LLM 4) generated draft for deliverable.

When the user presses the Manage Version button 2201 on the input screen 2200, the display of the user terminal 2 switches to the input screen 2210 (see FIG. 27B).

When the user selects “Upgrade and Register Update History” 2211 on the input screen 2210 and presses the Determine button 2212, the input screen 2220 is displayed on the user terminal 2 (see FIG. 27C).

When the user selects “Upgrade and Register Update History” 2211 and presses the Determine button 2212, the changes from the previous draft for deliverable are registered as an update history and allowed to be viewed at any time.

The input screen 2220 has a previous version display area 2230, a latest version display area 2240, an update history display area 2250, and a version bar 2260.

The latest version display area 2240 shows the latest version of the deliverable generated by the AI (LLM 4). In the latest version display area 2240, changes from one version are highlighted.

The one previous version display area 2230 displays one previous version of the deliverable displayed in the latest version display area 2240.

In the update history display area 2250, a list 2251 is displayed in which the number (No.), update date, update portion, update contents, updater, and version (Ver.) are stored in columns. In the list 2251, rows other than the latest version are highlighted (in gray) 2252 and rows with the latest version are highlighted (in white) 2253. Double-clicking on the row with the latest version highlights the row (in light blue) 2254, and the corresponding changes in the latest version display area 2240 are also highlighted.

The version bar 2260 has buttons that allow the user to select the version of the deliverable to be displayed in the latest version display area 2240 from the latest version to the version ten generations ago. The selection and pressing of the button allow the user to switch and view the version displayed in the latest version display area 2240. The contents of the previous version display area 2230 and the update history display area 2250 are changed in conjunction with the version displayed in the latest version display area 2240.

(d) Automatic Modification of the Deliverables of the Information Processing Device 10 through Dialogue between the User and the Information Processing Device 10.

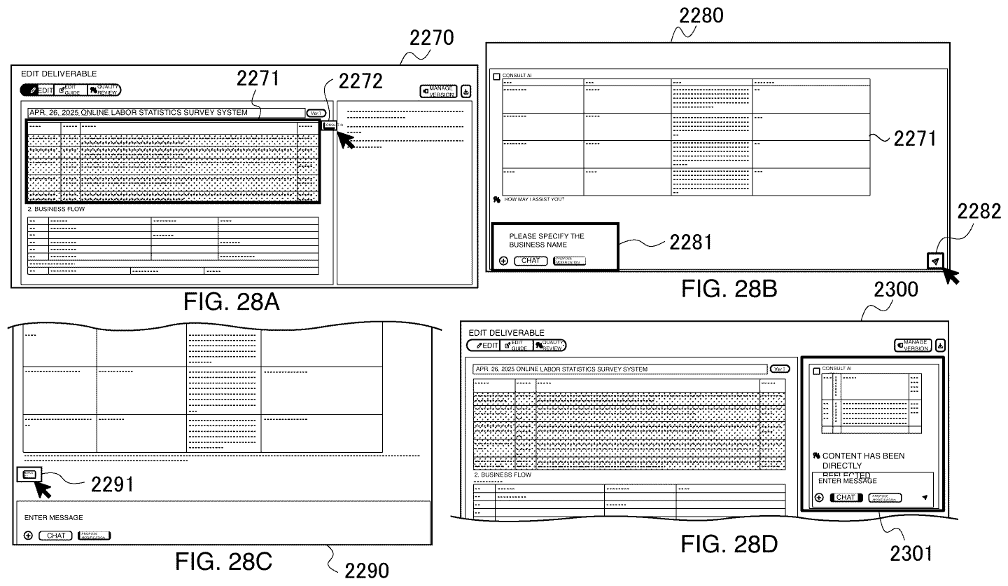

With reference to FIG. 28A though 28D, the automatic modification of the deliverables of the information processing device 10 through dialogue between the user and the information processing device 10 will be described.

The user terminal 2 transitions and displays the input screens 2270 to 2300 provided by the input screen provider 11.

As shown in FIG. 28A, the input screen 2270 displays the AI (LLM 4) generated draft for deliverable. When the user selects the portion 2271 that the user wishes to modify and presses the Consult AI button 2272, the screen transitions to the input screen 2280 and the portions 2271 that the user wishes to modify are cut out and displayed.

The user selects the modification proposal mode by pressing the Propose Modification button 2281 on the input screen 2280, enters the content of the modification request for the portion 2271 to be modified, and presses the paper plane button 2282. The modification content generated by the AI (LLM 4) is then displayed on the input screen 2290 (see FIG. 28C). The user can press the Reflect button 2291 if a problem is not recognized in the modification displayed on the input screen 2290, and can edit directly if the user determines that a problem is recognized in the modification.

When the user presses the Reflect button 2291 on the input screen 2290, the modification is reflected on the deliverable generated by the AI (LLM 4), the deliverable reflecting the modification is displayed on the input screen 2300, and the chat history 2301 between the user and the AI (LLM 4) is registered in the management information storage DB3 (see FIG. 28D).

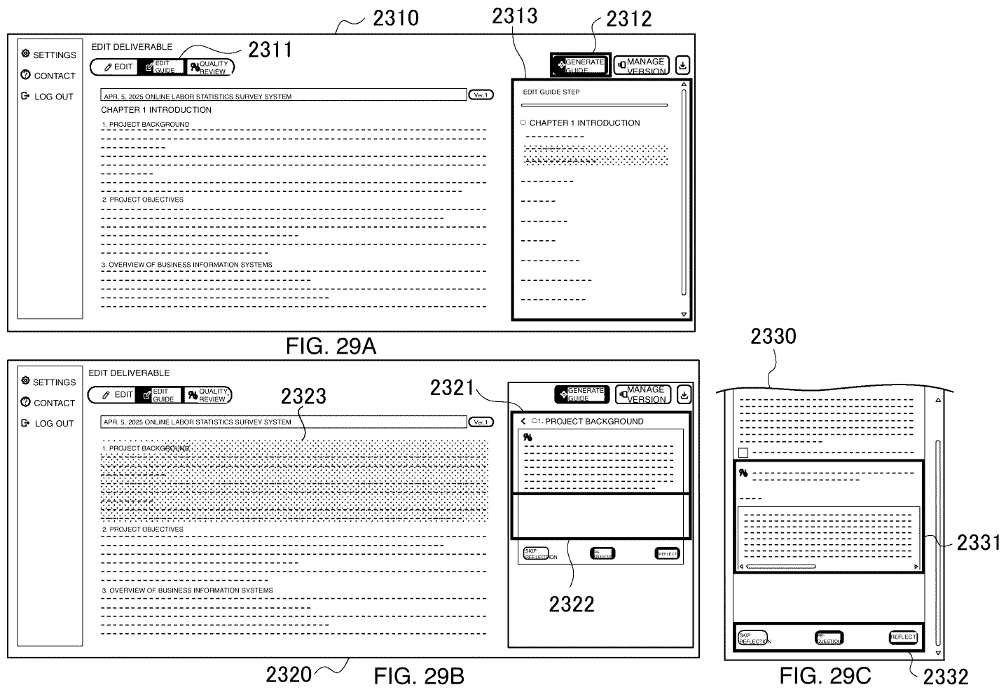

With reference to FIGS. 29A through 29C, the improvement of the deliverable by the responses of the user to the questions of the AI (LLM 4) will be described.

The user terminal 2 transitions and displays the input screens 2310 to 2330 provided by the input screen provider 11.

The input screen 2310 displays the deliverables generated by the AI (LLM 4). The user selects the Edit Guide tab 2311 displayed on the input screen 2310 and presses the Generate Guide button 2312, thereby causing the AI (LLM 4) to analyze the missing information for each table of contents of the deliverable, generate questions to the user, and display them in the display window 2313 (see FIG. 29A).

The user selects the first table of contents in the display window 2313, and the AI (LLM 4) transmits a request 2321 for information (see the input screen 2320 in FIG. 29C).

The user responds to the request 2321 for information by the AI (LLM 4) with a chat-style input 2322. The user may also provide information by attaching materials or photographs along with the response.

The AI (LLM 4) generates proposed modification 2331 to the relevant table of contents on the basis of the information provided by the user. The modified portion is highlighted in colored texts, for example (see FIG. 29C). The user may also edit directly.

The user is allowed to select from Reflection Skip, Re-AI Question, and Reflect by using the Select button 2332 to select from the AI (LLM 4) generated proposed modifications 2331. The selection of the Reflect button allows the proposed modification 2331 to be reflected on the deliverable generated by the AI (LLM 4).

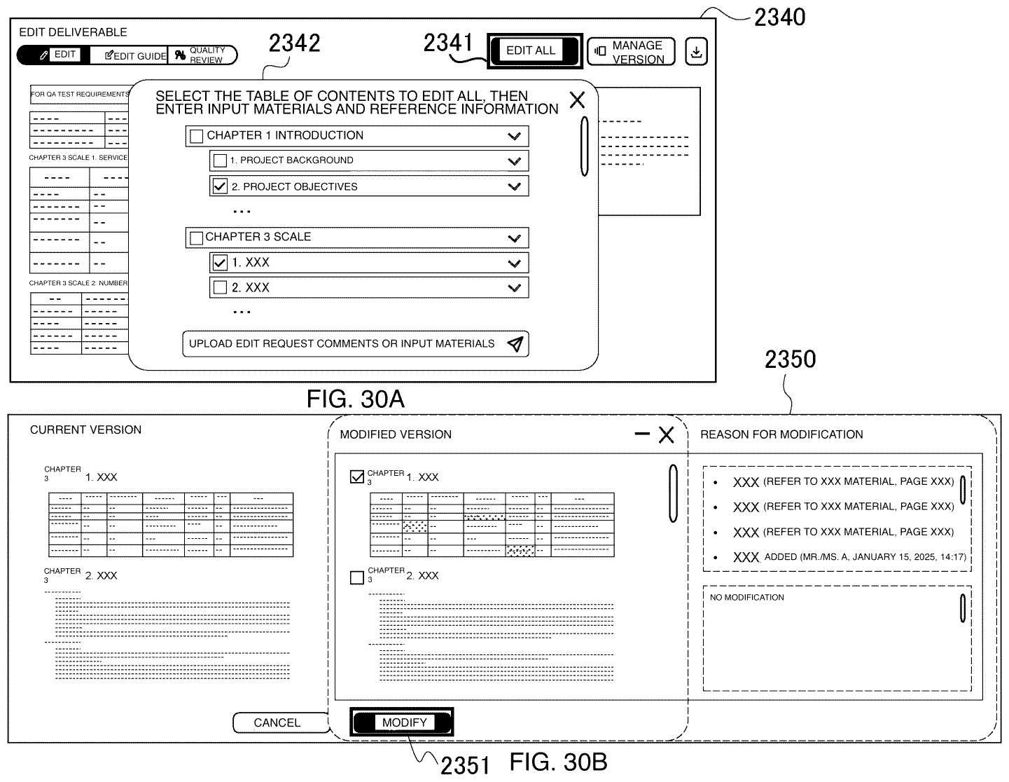

With reference to FIGS. 30A and 30B, the identification and batch modification of the deliverables by the AI (LLM 4) in conjunction with the minutes and other documents will be described.

The user terminal 2 transitions and displays the input screens 2340 and 2350 provided by the input screen provider 11.

The input screen 2340 displays the deliverables generated by the AI (LLM 4). The pop-up menu 2342 of the table of contents of deliverables is displayed by clicking the Edit All button 2341 on the input screen 2340. If the user puts a check mark in the table of contents to be edited and uploads comments or materials related to the table of contents to be edited, the AI (LLM 4) creates a proposed modification in consideration of the comments or materials. The V button on the pop-up menu 2342 allows the user to review the contents of the table of contents, and the x button closes the pop-up menu 2342.

The input screen 2350 displays the current version of the deliverable, the modified version of the deliverable as reviewed by the AI (LLM 4) on the basis of the input information, and the reason for the modification. The contents of the modified version of the deliverable are highlighted in blue or other colors to indicate the modifications. The contents of the modified version of the deliverable are directly editable by the user. The reason for modification displayed on the input screen 2350 includes a description of the reason for modification by the AI (LLM 4) and the cited input information. When the user presses the Modify button 2351, the deliverable is modified in a batch.

### (e) Overall Review of Deliverable on the Basis of the Pre-Registered Perspectives by the Information Processing Device 10 and Indication of Omissions in Requirements Consideration

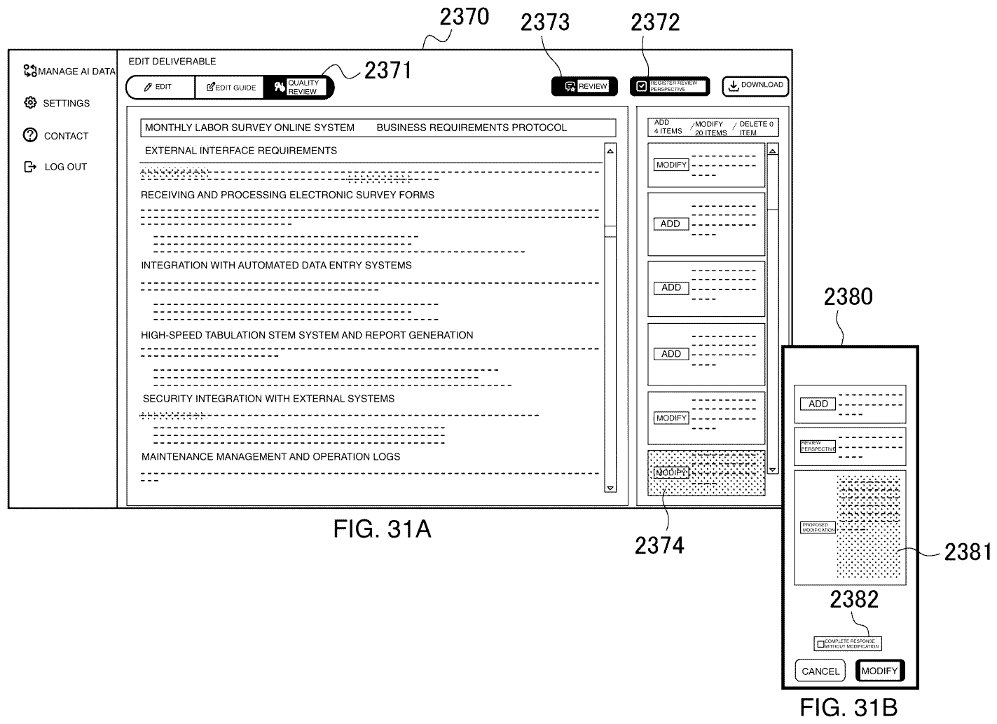

With reference to FIGS. 31A and 31B, an overall review of the deliverable and an indication of omissions in requirements consideration on the basis of the pre-registered perspectives by the information processing device 10 will be described.

The user terminal 2 transitions and displays the input screens 2370 to 2380 provided by the input screen provider 11.

As shown in FIG. 31A, the input screen 2370 displays the AI (LLM 4) generated draft for deliverable.

The user enters the quality review mode when the user selects the Quality Review tab 2731 on the input screen 2370. The user can register her/his own review perspective by pressing the Register Review Perspective button 2372. For example, the user is allowed to register her/his own request for proposal (RFP).

When the user presses the Review button 2373, the AI (LLM 4) starts reviewing the deliverable.

When the user clicks on the review card 2374, which contains the review generated by the AI (LLM 4), the display of the user terminal 2 transitions to the detail screen 2380.

The user can check and if needed, directly edit the proposed modification by the AI (LLM 4) displayed on the detail screen 2380, and when the user presses the Modify button 2382, the AI (LLM 4) generated proposed modification 2381 is reflected on the deliverable. If a check box 2383 is checked, the AI (LLM 4) proposed modification 2381 is not reflected and the response is completed without modification.

### Second Use Case

### (f) Upload of the Materials to the Information Processing Device 10 by the User, Overall Review of Deliverable on the Basis of Perspectives Registered in the Information Processing Device 10, and Indication of Omissions in Requirements Consideration

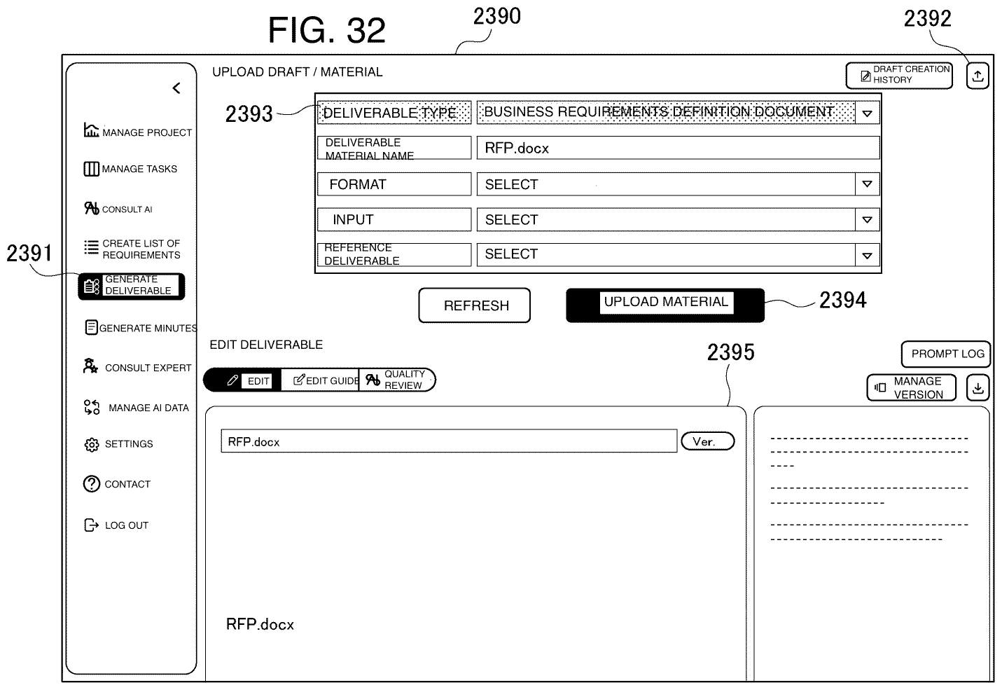

With reference to FIG. 32, a form in which the materials are uploaded by the user to the information processing device 10, and the entire deliverable is reviewed from the registered perspectives of the information processing device 10 to point out any omissions in requirements consideration will be described.

The user terminal 2 transitions and displays the input screen 2390 provided by the input screen provider 11.

As shown in FIG. 32, the input screen 2390 is displayed on the user terminal 2 by selecting the Generate Deliverable button 2391 on the sidebar.

By clicking on the Upload button 2392, the user selects a file (e.g., a Word (registered trademark) file of a request for proposal (RFP)) that is stored in the user terminal 2, for example.

The user selects a business requirements definition document from the pull-down menu in the deliverable type entry field 2393 and clicks on the Upload Material button to start uploading the material, which takes a few minutes to complete. The files that have been uploaded are displayed in the display window 2395.

The files uploaded to the information processing device 10 (e.g., request for proposal (RFP)) can be a subject to be reviewed by the information processing device 10 through the function described in (e) above.

A representative example of our devices, methods, and programs is described above with reference to the drawings. The specific configuration is not limited to this example, but includes various modifications within the scope that does not depart from the spirit of the appended claims.

1. An information processing device comprising:
a past deliverable acquisition unit configured to acquire past deliverables created in a past in a waterfall system development including a plurality of development steps;
a past deliverable analyzer configured to analyze a format of the past deliverables acquired by the past deliverable acquisition unit;
an input screen provider configured to provide an input screen for entering input items needed for creating a new deliverable;
a prompt generator configured to generate a prompt for automatically generating a new deliverable based on the format of the past deliverables analyzed by the past deliverable analyzer and the input items entered on the input screen provided by the input screen provider;
a prompt provider configured to provide the prompt generated by the prompt generator to a large language model;
a new deliverable acquisition unit configured to acquire, from the large language model, the new deliverable generated in response to the prompt provided by the prompt provider; and
a new deliverable provider configured to provide the new deliverable acquired by the new deliverable acquisition unit.

2. The information processing device according to claim 1, wherein
the past deliverable acquisition unit acquires past deliverables created in any of the development steps in the waterfall system development, and
the input screen provider provides an input screen for creating a new deliverable in a development step downstream from the development steps in which the acquired past deliverables have been created based on the past deliverable acquired by the past deliverable acquisition unit.

3. The information processing device according to claim 1, further comprising:
a defect determination unit configured to determine a defect in the input items entered on the input screen provided by the input screen provider based on the new deliverable acquired by the new deliverable acquisition unit, wherein
the input screen provider provides an input screen for entering additional input items in accordance with the defect determined by the defect determination unit, and
the prompt generator generates a prompt for correcting the defect determined by the defect determination unit based on the additional input items entered on the input screen.

4. The information processing device according to claim 1, further comprising:
a consistency determination unit configured to determine consistency among a plurality of description items in the new deliverable acquired by the new deliverable acquisition unit; and
a description item modification unit configured to modify the description items based on the consistency determined by the consistency determination unit.

5. The information processing device according to claim 1, further comprising:
an association recorder configured to record associations among a plurality of new deliverables respectively generated in a plurality of development steps acquired by the new deliverable acquisition unit; and
a modification reflection unit configured to reflect a modification performed on the new deliverable generated in any one of the development steps on another new deliverable generated in another development step based on the associations recorded by the association recorder.

6. The information processing device according to claim 1, wherein
the input screen provider is configured to provide an input screen for further acquiring a screen specification document of a display screen displayed in a system and a screen transition diagram of the display screen; and
the prompt generator is configured to generate a prompt for automatically generating a program for displaying the display screen based on the screen specification document and the screen transition diagram acquired in the input screen provider.

7. The information processing device according to claim 1, wherein
the input screen provider is configured to provide a management screen that displays deliverables created in a plurality of development steps included in the waterfall system development for each of the development steps; and
the deliverables are displayed on the management screen along with a direction of an input to a subsequent deliverable.

8. The information processing device according to claim 1, wherein
the new deliverable acquisition unit is configured to acquire at least one of a material and programming code generated in response to the prompt from the large language model as a new deliverable.

9. An information processing method causing a computer to execute the steps of:
acquiring past deliverables created in a past in a waterfall system development including a plurality of development steps;
analyzing a format of the past deliverables acquired in the past deliverable acquiring step;
providing an input screen for entering input items needed for creating a new deliverable;
generating a prompt for automatically generating the new deliverable based on the format of the past deliverables analyzed in the past deliverable analyzing step and the input items entered on the input screen provided in the input screen providing step;
providing the prompt generated in the prompt generating step to a large language model;
acquiring, from the large language model, the new deliverable generated in response to the prompt provided in the prompt providing step; and
providing the new deliverable acquired in the new deliverable acquiring step.

10. An information processing program causing a computer to embody the processes of:
acquiring past deliverables created in a past in a waterfall system development including a plurality of development steps;
analyzing a format of the past deliverables acquired in the past deliverable acquiring process;
providing an input screen for entering input items needed for creating a new deliverable;
generating a prompt for automatically generating the new deliverable based on the format of the past deliverables analyzed in the past deliverable analyzing process and the input items entered on the input screen provided in the input screen providing process;
providing the prompt generated in the prompt generating process to a large language model;
acquiring, from the large language model, the new deliverable generated in response to the prompt provided in the prompt providing process; and
providing the new deliverable acquired in the new deliverable acquiring process.
